(19) United States
(12) Patent Application Publication
(10) Pub. No.: US 2024/0369950 A1
(43) Pub. Date: Nov. 7, 2024

(54) TONER

(71) Applicant: CANON KABUSHIKI KAISHA, Tokyo (JP)

(72) Inventors: KENTA KAMIKURA, Kanagawa (JP); SHOHEI TSUDA, Shizuoka (JP); TORU ISHII, Shizuoka (JP)

(21) Appl. No.: 18/645,908

(22) Filed: Apr. 25, 2024

(30) Foreign Application Priority Data
May 2, 2023 (JP) 2023-076059

(51) Int. Cl. G03G 9/097; G03G 9/087

(52) U.S. Cl. CPC G03G 9/09775; G03G 9/08755; G03G 9/09733

(57) ABSTRACT

A toner comprising a toner particle comprising a binder resin, and an external additive, wherein the external additive comprises a fatty acid metal salt particle; the toner comprises fumaric acid; with a (mol/g) as a content of the fumaric acid in the toner, and with b (mol/g) as a content of the fatty acid metal salt particle in the toner, Formula (1) below is satisfied:

$$0.50 \leq a / b \leq 70 \text{.00} . \qquad ( 1 )$$

### BACKGROUND OF THE INVENTION

### Field of the Invention

The present disclosure relates to a toner which is used in recording methods that rely on electrophotography, electrostatic recording and toner jet recording.

### Description of the Related Art

Electrophotographic image formation has come to be adopted in a wide variety of fields, from printers and copiers to commercial printing machines. In conjunction with this, the uses of electrophotographically obtained images are likewise becoming more diverse.

Against this background the use of electrophotographic images is expanding, also for instance on the exterior of products, and a problem of image loss has arisen that derives from image rubbing at the time of stacking and transportation processes in logistics.

To counter such image loss measures have been taken that are aimed at increasing the strength of the image surface and improving the slipperiness of the image surface.

Japanese Patent Application Publication No. 2022-052627 discloses a toner containing a toner particle that contains an amorphous polyester resin synthesized using fumaric acid as a monomer and a crystalline polyester resin, and particles of a fatty acid metal salt.

Meanwhile, Japanese Patent Application Publication No. 2016-173396 discloses a toner in which the content of monomers therein having a carboxylic acid group is stipulated, for the purpose of improving the low-temperature fixability, heat-resistant storability, charging stability (charge rising performance) and anti-contamination properties of the toner, and suppressing toner scattering and soiling within the equipment.

### SUMMARY OF THE INVENTION

Studies by the inventors have revealed that images formed using the toner disclosed in Japanese Patent Application Publication No. 2022-052627 exhibits excellent surface slipperiness, brought about by the lubricant action of fatty acid metal salt particles. However, a gradual loss of image slipperiness has become manifest in cases where the surface of images formed using the toner disclosed in Japanese Patent Application Publication No. 2022-052627 is rubbed for a prolonged time. Image strength drops as a result, which is problematic, and thus the inventors discerned the need for improvements in this respect.

The toner disclosed in Japanese Patent Application Publication No. 2016-173396 was ineffective in terms of improving image surface slipperiness.

As pointed out above no toner has been obtained, in conventional approaches, that allows maintaining the slipperiness of an image surface while suppressing image loss upon prolonged rubbing; the inventors thus perceived the need for improvements in this regard.

To solve the above problems, the present disclosure provides a toner that allows maintaining image slipperiness while suppressing image loss, even upon prolonged rubbing of the image, i.e. provides a toner having high image abrasion resistance.

The present disclosure relates to a toner comprising
a toner particle comprising a binder resin, and
an external additive,
wherein the external additive comprises a fatty acid metal salt particle;
the toner comprises fumaric acid;
with a (mol/g) as a content of the fumaric acid in the toner, and
with b (mol/g) as a content of the fatty acid metal salt particle in the toner, Formula (1) below is satisfied:

$$0.50 \leq a / b \leq 70 \text{.00} . \qquad ( 1 )$$

The present disclosure succeeds in providing a toner that allows maintaining image slipperiness, while suppressing image loss, also upon prolonged image rubbing. Further features of the present invention will become apparent from the following description of exemplary embodiments.

### DESCRIPTION OF THE EMBODIMENTS

In the present disclosure, the wordings “from XX to YY” and “XX to YY” expressing numerical value ranges mean numerical value ranges including the lower limit and the upper limit as endpoints, unless otherwise stated. When numerical value ranges are described stepwise, upper limits and lower limits of those numerical value ranges can be combined suitably.

The term “monomer unit” describes a reacted form of a monomeric material in a polymer. For example, one carbon-carbon bonded section in a principal chain of polymerized polymerizable monomers in a polymer is given as one unit. A polymerizable monomer can be represented by the following formula (C).

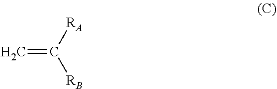

In formula (C), R_{A} represents a hydrogen atom or alkyl group (preferably an alkyl group having 1 to 3 carbon atoms, or more preferably a methyl group), and R_{B} represents any substituent.

The present disclosure relates to a toner comprising
a toner particle comprising a binder resin, and
an external additive,
wherein the external additive comprises a fatty acid metal salt particle;
the toner comprises fumaric acid;
with a (mol/g) as a content of the fumaric acid in the toner, and
with b (mol/g) as a content of the fatty acid metal salt particle in the toner, Formula (1) below is satisfied:

$$0.50 \leq a / b \leq 70 \text{.00} . \qquad ( 1 )$$

The inventors conjectured the following concerning the underlying reasons for the fact that the toner of the present disclosure allows maintaining image slipperiness, while suppressing image loss, also upon prolonged image rubbing.

The inventors surmise that one cause of the decrease in image slipperiness in prolonged rubbing of an image obtained using toner having a fatty acid metal salt particle as an external additive is detachment, caused by rubbing, of the fatty acid metal salt particle present on the image surface. That is, the image after image formation has, on the surface thereof, a fatty acid metal salt particle that acts as a lubricant, thanks to which the image exhibits high slipperiness and image loss can be suppressed. When on the other hand the image is rubbed for a prolonged time, the fatty acid metal salt particle that acts as a lubricant detaches, and image slipperiness decreases. As a result, image strength drops and image loss occurs.

The inventors surmised therefore that detachment of a fatty acid metal salt particle from images must be suppressed in order to solve the problems of the present disclosure.

The underlying reason for detachment of a fatty acid metal salt particle caused by rubbing is deemed to be the high mobility of molecules of the fatty acid metal salt, which is a low molecular compound. It was therefore conjectured that crosslinking of fatty acid metal salts, to thereby increase the apparent molecular weight, may be effective with a view to suppressing detachment of a fatty acid metal salt particle.

Diligent research by the inventors in the light of the above considerations has revealed that detachment of a fatty acid metal salt particle caused by image rubbing can be suppressed, and image loss after rubbing can likewise be suppressed, by incorporating fumaric acid into the toner, and by controlling a molar ratio of the content of fumaric acid in the toner and the content of a fatty acid metal salt particle in the toner.

That is arguably because the apparent molecular weight of the fatty acid metal salt molecules is increased through crosslinking, elicited by the fumaric acid, of metal atoms in the fatty acid metal salt molecules in a fixing step during the image forming process. Fumaric acid has a double bond and a trans-type molecular structure, and accordingly tends to yield linear structures. Moreover, the molecular size of fumaric acid is close to the distance between metal atoms in fatty acid metal salts. Such being the case, fumaric acid is accordingly suitable for crosslinking between metal atoms of fatty acid metal salts. It is thought that, in consequence, fumaric acid may bring out crosslinking properties, between fatty acid metal salt molecules, that are superior to those of other dicarboxylic acids.

The present disclosure will be explained in detail below.

The toner comprises a toner particle comprising a binder resin, and an external additive. The external additive comprises a fatty acid metal salt particle. The toner comprises fumaric acid. The toner satisfies Formula (1) below with a (mol/g) as a content of fumaric acid in the toner and with b (mol/g) as a content of the fatty acid metal salt particle in the toner.

$$0.50 \leq a / b \leq 70.00 \qquad ( 1 )$$

In Formula (1) above, a/b represents the molar ratio of the content of fumaric acid in the toner relative to the content of a fatty acid metal salt particle in the toner. The content b (mol/g) of the fatty acid metal salt particle in the toner is obtained by dividing the content (g) of the fatty acid metal salt particle in the toner by the molecular weight of the fatty acid metal salt, to yield the content (number of moles) of the fatty acid metal salt particle in the toner, and by further converting the content (number of moles) to a value referred to the toner mass (g). A concrete method for measuring b will be described below.

The ratio of the number of fumaric acid in the toner relative to the number of fatty acid metal salt is optimized when Formula (1) above is satisfied. As a result, the degree of crosslinking between fatty acid metal salt molecules becomes optimal, and the abrasion resistance of the image is improved. A crosslinking rate between fatty acid metal salt molecules in the fixing step becomes adequate, and accordingly the fixation temperature does not rise.

In a case where a/b is lower than 0.50, the degree of crosslinking between fatty acid metal salt molecules may be insufficient, and the effect of image loss suppression may be poor. In a case by contrast where a/b exceeds 70.00, the content of fumaric acid relative to the content of the fatty acid metal salt particle in the toner is excessively high, and as a result crosslinking may in some instances progress early in a fixing step. It is considered that the fixation temperature may rise as a result. Herein a/b is calculated from values obtained by measuring a and b in accordance with the below-described method.

Further, a/b is more preferably from 1.20 to 70.00, yet more preferably from 1.50 to 70.00, even yet more preferably from 1.50 to 60.00, particularly preferably from 2.00 to 50.00, and especially preferably from 2.00 to 30.00.

A content a (mol/g) of fumaric acid in the toner is preferably from 8.60×10⁻⁷ to 1.25×10⁻⁵ mol/g, more preferably from 8.60×10⁻⁷ to 1.05×10⁻⁵ mol/g. The content of fumaric acid in the toner becomes more appropriate when the above condition is satisfied. Fumaric acid has charging performance and hygroscopicity. Therefore, by properly adjusting the content of fumaric acid it becomes possible to achieve both charge quantity and rise-up of charging, in a high-temperature, high-humidity environment, and to curtail drops in image density in such an environment. A method for measuring the content a of fumaric acid in the toner will be described further on. The fact that a is measured in accordance with the below-described method is indicative of the fact that fumaric acid in the toner is present in a free state. The value of the content a of fumaric acid in the toner can be adjusted by modifying the addition amount of fumaric acid during production of the toner.

The method for incorporating fumaric acid into the toner is not particularly limited, and any known method can be resorted to. For instance fumaric acid may be incorporated into a toner particle contained in the toner. That is, the toner particle preferably comprises fumaric acid.

Specifically, in a case where the toner particle is produced in accordance with a pulverization method, a means may be resorted to in which fumaric acid is added beforehand to a starting-material resin, or a means may be resorted to in which fumaric acid is added to and incorporated into the toner particle at the time of melt-kneading of starting materials.

When producing the toner particle in accordance with a wet method such as suspension polymerization or emulsification aggregation, a means may be resorted to in which fumaric acid is incorporated into the starting materials, or alternatively, a means may be resorted to in which fumaric acid is added, by way of an aqueous medium, during the production process.

Fumaric acid may be externally added to the toner particle using a known external addition means.

The content b (mol/g) of a fatty acid metal salt particle in the toner is more preferably from 1.55×10⁻⁷ to 7.90×10⁻⁶ mol/g. The content of the fatty acid metal salt particle in the toner is appropriate when the above condition is satisfied. The abrasion resistance of the image can be further enhanced as a result. The fatty acid metal salt also acts as a lubricant. Therefore, by adjusting the content of the fatty acid metal salt particle properly it becomes possible to improve slipperiness between the cleaning blade and the photosensitive member in a system that utilizes a blade cleaning scheme. The cleaning performance of the external additive that migrates from the toner to the photosensitive member can be improved as a result. A method for measuring the content b of the fatty acid metal salt particle in the toner will be described further on. The value of the content b of the fatty acid metal salt particle in the toner can be adjusted through modification of the addition amount of the fatty acid metal salt particle during production of the toner.

Materials that can be used in the toner of the present disclosure will be described in detail next.

### Fatty Acid Metal Salt

The toner comprises an external additive. The external additive comprises a fatty acid metal salt particle.

Known fatty acid metal salts can be used, without particular limitations, as the fatty acid metal salt.

The fatty acid metal salt is preferably a salt of a divalent or higher polyvalent metal, and more preferably a salt of at least one metal selected from the group consisting of zinc, barium, aluminum, magnesium and calcium. Among the foregoing, zinc salts are more preferred, from the viewpoint of crosslinking properties with fumaric acid. Zinc salts have high crosslinking properties with fumaric acid, and thus facilitate further enhancing of abrasion resistance.

The fatty acid of the fatty acid metal salt is not particularly limited, but may be an unsaturated fatty acid, but is preferably a saturated fatty acid.

The fatty acid may be linear or branched, but is preferably linear. The fatty acid preferably has from 10 to 24 carbon atoms, more preferably from 12 to 22 carbon atoms. When the number of carbon atoms in the fatty acid lies the above range, formation of a crosslinked structure between fumaric acid and the metal atoms of the fatty acid metal salt is not hindered, and image abrasion resistance can be further enhanced. Given that the heat resistance of the image is improved through crosslinking between the metal atoms of the fatty acid metal salt, the abrasion resistance of the image can therefore be preserved even when the image is exposed to high temperature. Also the cleaning performance of the external additive is further improved, since the fatty acid metal salt affords excellent slipperiness.

Examples of fatty acids include at least one selected from the group consisting of octylic acid, nonylic acid, capric acid, undecylic acid, lauric acid, myristic acid, palmitic acid, stearic acid, behenic acid and montanic acid, preferably at least one selected from the group consisting of lauric acid, myristic acid, palmitic acid, stearic acid and behenic acid, and yet more preferably stearic acid.

Concrete examples of fatty acid metal salts include zinc stearate, zinc montanate, zinc behenate, zinc laurate, aluminum stearate, aluminum octylate, barium stearate and barium ricinoleate. Zinc stearate, aluminum stearate and barium stearate are preferred among the foregoing. Zinc stearate is more preferable.

The solubility parameter SPf ((J/cm³)^{1/2}) of the fatty acid metal salt is not particularly limited, but is preferably from 18.00 to 21.00 ((J/cm³)^{1/2}), more preferably from 18.50 to 20.50 ((J/cm³)^{1/2}), and yet more preferably from 18.50 to 19.50 ((J/cm³)^{1/2}). When SPf lies within the above ranges, a below-described ΔSPfw can be readily controlled so as to lie within a preferable range.

The volume-basis median diameter of the fatty acid metal salt particle is preferably from 0.15 to 2.0 μm, more preferably from 0.3 to 1.5 μm, and yet more preferably from 0.3 to 1.0 μm. Excellent abrasion resistance and cleaning performance can be achieved, even with a low content of a fatty acid metal salt particle, when the volume-basis median diameter lies within the above ranges.

### Binder Resin

The toner comprises a toner particle. The toner particle comprises a binder resin.

As the binder resin there can be used known binder resins, without particular limitations. Concrete examples include polyester resins, vinyl resins, polyurethane resins and polyamide resins. The binder resin preferably includes a polyester resin, and more preferably includes a polyester resin having a monomer unit corresponding to fumaric acid, since in that case fumaric acid is readily held in the toner.

As the polyester resin there is preferably used at least one selected from the group consisting of amorphous polyester resins and crystalline polyester resins.

The above polyester resin can be obtained through synthesis, in accordance with a known method such as transesterification or polycondensation, of combinations of suitably selected compounds such as a polyvalent carboxylic acid, a polyol, and/or a hydroxycarboxylic acid.

A polyvalent carboxylic acid is a compound containing two or more carboxy groups in the molecule. Among the foregoing there is preferably used a dicarboxylic acid compound containing two carboxy groups in the molecule.

Examples of the dicarboxylic acid include for instance fumaric acid, oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylene diacetic acid, m-phenylenediacetic acid, o-phenylene diacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid and cyclohexanedicarboxylic acid.

As mentioned above, the resin preferably contains fumaric acid as the dicarboxylic acid; more preferably, fumaric acid and an aromatic dicarboxylic acid are used concomitantly.

Examples of polyvalent carboxylic acids other than dicarboxylic acids include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid, n-dodecylsuccinic acid, n-dodecenylsuccinic acid, isododecylsuccinic acid, isododecenyl succinic acid, n-octylsuccinic acid and n-octenylsuccinic acid,

The polyvalent carboxylic acid may be used singly, or two or more types thereof may be used concomitantly.

A polyol is a compound containing two or more hydroxyl groups in the molecule. Among the foregoing, there is preferably used a diol which is a compound containing two hydroxyl groups in the molecule.

Specific examples include ethylene glycol, diethylene glycol, triethylene glycol, 1,2-propylene glycol, 1,3-propylene glycol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, 1,4-cyclohexanediol, polytetramethylene glycol, as well as hydrogenated bisphenol A, bisphenol A, bisphenol F, bisphenol S, and also alkylene oxide (ethylene oxide, propylene oxide, butylene oxide or the like) adducts of these bisphenols. Preferred among the foregoing are alkylene glycols having 2 to 12 carbon atoms and alkylene oxide adducts of bisphenols, particularly preferably alkylene oxide adducts of bisphenols.

Examples of trihydric or higher polyols include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac and alkylene oxide adducts of the foregoing trihydric or higher polyphenols.

The polyol may be used singly, or alternatively two or more types of polyols may be used concomitantly.

The solubility parameter SPp ((J/cm³)^{1/2}) of the polyester resin is not particularly limited, but may be from 19.00 to 22.50 (J/cm³)^{1/2} or may be from 20.00 to 21.30 (J/cm³)^{1/2}. The solubility parameter SPp is preferably from 20.50 to 21.30 (J/cm³)^{1/2}, and more preferably from 21.10 to 21.30 (J/cm³)^{1/2}. When the solubility parameter of the polyester resin lies within the above ranges, the below-described value of the product of the square of ASP and the molecular weight of the release agent can be readily adjusted to lie within the range described below.

The solubility parameter, also referred to as SP value, is a numerical value used as an index of solubility or affinity, and denotes to what extent a substance is dissolved in another substance.

The type of the binder resin can be measured in accordance with a known method such as NMR.

The content of the binder resin relative to 100 parts by mass of toner particle is not particularly limited, but may be from 50.0 to 98.0 parts by mass, or from 60.0 to 95.0 parts by mass.

The peak molecular weight (Mp) of the binder resin is not particularly limited, but is preferably from 5000 to 10000, more preferably from 5000 to 8000. When the peak molecular weight of the binder resin lies within the above ranges, the mobility of fumaric acid and of the fatty acid metal salt at the time of fixing increases, and as a result fumaric acid can elicit crosslinking of fatty acid metal salt molecules more efficiently. It becomes therefore possible to further improve the abrasion resistance of the image.

In a case for instance where a polyester resin is used as the binder resin, the peak molecular weight of the binder resin can be controlled in accordance with a known method such as control of the reaction time.

### Release Agent

Preferably, the toner particle comprises a release agent. Thanks to the presence of the release agent in the toner particle, a release agent layer becomes formed on the image surface, so that the strength of the image surface increases as a result.

For instance known waxes and silicone oil can be used, without particular limitations, as the release agent. A wax is preferably used among the foregoing.

Concrete examples of the wax include petroleum hydrocarbon waxes and derivatives thereof such as paraffin wax, microcrystalline wax and petrolatum, and derivatives of the foregoing, as well as montan wax and derivatives thereof, Fischer-Tropsch hydrocarbon waxes and derivatives thereof; and also
ester waxes such as monofunctional ester waxes typified by esters of a monohydric alcohol and an aliphatic carboxylic acid or esters of a monovalent carboxylic acid and an aliphatic alcohol, such as behenyl behenate, stearyl stearate and palmityl palmitate;
bifunctional esters waxes typified by esters of a dihydric alcohol and an aliphatic carboxylic acid and esters of a divalent carboxylic acid and an aliphatic alcohol, such as ethylene glycol distearate, dibehenyl sebacate and hexanediol dibehenate;
trifunctional ester waxes typified by esters of a trihydric alcohol and an aliphatic carboxylic acid or esters of a trivalent carboxylic acid and aliphatic alcohol, such as glycerol tribehenate;
tetrafunctional ester waxes typified by esters of a tetrahydric alcohol and an aliphatic carboxylic acid or esters of a tetravalent carboxylic acid and an aliphatic alcohol, such as pentaerythritol tetrastearate and pentaerythritol tetrapalmitate;
hexafunctional ester waxes typified by esters of a hexahydric alcohol and an aliphatic carboxylic acid or esters of a hexavalent carboxylic acid and an aliphatic alcohol, such as dipentaerythritol hexastearate and dipentaerythritol hexapalmitate;
esters of polyhydric alcohols and aliphatic carboxylic acids or esters of polyhydric carboxylic acids and aliphatic alcohols, such as polyglycerol behenate; and
natural ester waxes such as carnauba wax and rice wax;

Other examples include polyolefin hydrocarbon waxes and derivatives thereof, such as polyethylene and polypropylene, and natural waxes and derivatives thereof, such as carnauba wax and candelilla wax.

Derivatives also include oxides, block copolymers, and graft-modified products with vinyl monomers.

Further examples include alcohols such as higher aliphatic alcohols; fatty acids such as stearic acid and palmitic acid, acid amides, esters and ketones of the foregoing; hardened castor oil and derivatives thereof, as well as vegetable waxes and animal waxes. The foregoing may be used singly; alternatively, two or more types of the foregoing may be used concomitantly.

Preferred among the foregoing are at least one selected from the group consisting of hydrocarbon waxes and ester waxes, and yet more preferably at least one selected from the group consisting of Fischer-Tropsch hydrocarbon waxes, tetrafunctional ester waxes and hexafunctional ester waxes. These waxes have high crystallinity, and accordingly readily form a uniform release agent layer on an image surface, and are excellent in terms of eliciting an effect of enhancing the strength of the image surface.

The content of the release agent is preferably from 1.0 to 30.0 parts by mass, and more preferably from 5.0 to 20.0 parts by mass, relative to 100.0 parts by mass of the binder resin.

The melting point of the release agent is preferably from 60 to 120° C., more preferably from 70 to 120° C., and yet more preferably from 80 to 120° C. The heat resistance of the image can be further increased by using a release agent having a melting point within the above ranges.

A solubility parameter SPw ((J/cm³)^{1/2}) of the release agent is not particularly limited, but may be from 16.50 to 19.00 (J/cm³)^{1/2}, or from 17.00 to 18.50 (J/cm³)^{1/2}. When SPw lies within the above ranges, the below-described value of the square of ΔSPpw and the molecular weight of the release agent can be readily adjusted to lie within the above range. The molecular weight of the release agent is not particularly limited, but may be from 500 to 1800, and preferably from 700 to 1500. When the molecular weight of the release agent lies within the above ranges, the below-described value of the product of the square of ΔSPpw and the molecular weight of the release agent can be readily adjusted to lie within the below-described ranges.

Relationship Between the Solubility Parameter of the Polyester Resin and the Solubility Parameter and Molecular Weight of the Release Agent

In a toner in which the binder resin comprised in the toner particle comprises in turn a polyester resin, and the toner particle comprises a release agent, and with SPp ((J/cm³)^{1/2}) as the solubility parameter of the polyester resin, SPw ((J/cm³)^{1/2}) as a solubility parameter of the release agent, and ΔSPpw as a difference between SPp and SPw, a product of the square of ΔSPpw and a molecular weight of the release agent is preferably 10000.00 (J/cm³) or more, more preferably 11000.00 (J/cm³) or more, and yet more preferably 12000.00 (J/cm³) or more. The upper limit is not particularly restricted, but may be 20000.00 (J/cm³) or less, or 15000.00 (J/cm³) or less. For instance, the above value is preferably from 10000.00 to 20000.00 (J/cm³), or from 11000.00 to 15000.00 (J/cm³), or from 12000.00 to 15000.00 (J/cm³).

The value of the product of the square of ΔSPpw and the molecular weight of the release agent represents the ease with which a resin and a release agent separate from each other. When the above value is 10000 or more, the release agent separates quickly in the fixing step, to form a strong release agent layer on the image surface. The surface of the fixed image becomes protected as a result. In consequence, slipperiness derived from the fatty acid metal salt can be enhanced, and in conjunction therewith, also the strength of the fixed image can be further increased; the taping resistance of the image upon image taping, as well as abrasion resistance of the image, are likewise improved.

A method for calculating the solubility parameter and a method for calculating the molecular weight of the release agent will be described further on.

Relationship Between the Solubility Parameter of the Fatty Acid Metal Salt and the Solubility Parameter of the Release Agent

In a toner in which the toner particle comprises a release agent, and with SPf ((J/cm³)^{1/2}) as a solubility parameter of the fatty acid metal salt, SPw ((J/cm³)^{1/2}) as a solubility parameter of the release agent, and ΔSPfw as a difference between SPf and the SPw, ΔSPfw is preferably from 0.00 to 3.00 ((J/cm³)^{1/2}), more preferably from 0.20 to 1.60 ((J/cm³)^{1/2}), and yet more preferably 0.30 to 0.80 ((J/cm³)^{1/2}).

When ΔSPfw lies within the above ranges it becomes possible to improve the dispersibility of the fatty acid metal salt particle on the surface of a fixed image, which translates into a more uniform image surface. Images with higher gloss can be obtained as a result, even after rubbing.

### Method for Calculating a Solubility Parameter (SP Value)

The solubility parameter SPf of the fatty acid metal salt, the solubility parameter SPp of the polyester resin, and the solubility parameter SPw of the release agent are worked out as follows in accordance with the calculation method proposed by Fedors.

To calculate the SP value of the fatty acid metal salt (SPf) (J/cm³)^{1/2} and the SP value of the release agent (SPw) (J/cm³)^{1/2}, the evaporation energy (Δei) (J/mol) and molar volume (Δvi) (cm³/mol) of the atoms or atomic groups in the molecular structure of the fatty acid metal salt and of the release agent are worked out on the basis of the tables given in “Polym. Eng. Sci., 14 (2), 147-154 (1974)”.

$${( ΣΔ ei / ΣΔ vi )}^{1 / 2}$$

To calculate the SP value of the polyester resin (SPp) (J/cm³)^{1/2}, firstly the SP value of repeating units that make up the polyester resin are worked out as follows. The term repeating units that make up the polyester resin signifies herein molecular structures, in the main chain of the polyester resin, separated by ester bonds.

For instance to calculate the SP value (om) (J/cm³)^{1/2} of the repeating units, the evaporation energy (Δei) (J/mol) and molar volume (Δvi) (cm³/mol) of the atoms or atomic groups in the respective molecular structures of the repeating units are worked out on the basis of the tables given in “Polym. Eng. Sci., 14 (2), 147-154 (1974)”.

$$σ m = {( ΣΔ ei / ΣΔ vi )}^{1 / 2}$$

The SP value (SPp) of the polyester resin is then worked out by calculating the evaporation energy (Δei) and molar volume (Δvi) of the repeating units that makes up the resin, for each repeating unit. The products of the evaporation energy (Δei) and of the molar volume (Δvi) by the respective molar ratio (j) of the repeating units are thereupon calculated, and the sum total of the evaporation energies are divided by the sum total of the molar volumes, in accordance with the calculation expression below, to work out the solubility parameter.

$$σ p = {\{ ( Σ j \times Σ Δ e i ) / ( Σ j \times Σ Δ v i ) \}}^{1 / 2}$$

Assuming for instance that the polyester resin is made up of two types of repeating units, X and Y, the solubility parameter (SPp) of the resin is worked out in accordance with the expression below where Wx and Wy (mass %) are the composition ratios, Mx and My are the molecular weights, Δei (X) and Δei (Y) are the evaporation energy, and Δvi (X) and Δvi (Y) are the molar volume of the repeating units, and where the molar ratios (j) of the repeating units are Wx/Mx and Wy/My.

$${SPp = [ \{ ( Wx / Mx \times Δ ei ( X ) + Wy / My \times Δ ei ( Y ) \} / ( Wx / Mx ) \times Δ vi ( X ) + Wy / My \times Δ vi ( Y ) \} ]}^{1 / 2}$$

In a case where multiple types of polyester resins are mixed, SPp denotes herein the SP value of the resulting mixture. The SP value (σM) of the mixture is calculated as the product of the mass composition ratio (Wi) of the mixture and the SP values (σi) of the respective resins, according to the expression below.

$$σ M = Σ ( Wi \times σ i )$$

### Plasticizer

The toner particle may also contain a plasticizer. The plasticizer is not particularly limited, and the waxes exemplified in the section pertaining to the release agent can be used herein.

### Colorant

The toner particle may contain a colorant. As the above colorant there can be used known pigments and dyes, of black, yellow, magenta, cyan colors, and of other colors, and a magnetic body without particular limitations.

Black colorants include black pigments such as carbon black.

Yellow colorants include yellow pigments and yellow dyes such as monoazo compounds; disazo compounds; condensed azo compounds; isoindolinone compounds; benzimidazolone compounds; anthraquinone compounds; azo metal complexes; methine compounds; and allylamide compounds.

Concrete examples include C. I. Pigment Yellow 74, 93, 95, 109, 111, 128, 155, 174, 180 and 185, and C. I. Solvent Yellow 162.

Magenta colorants include magenta pigments and magenta dyes such as monoazo compounds; condensed azo compounds; diketopyrrolopyrrole compounds; anthraquinone compounds; quinacridone compounds; basic dye lake compounds; naphthol compounds; benzimidazolone compounds; thioindigo compounds and perylene compounds.

Specifically, C. I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, 238, 254 and 269, and C. I. Pigment Violet 19.

Examples of cyan colorants include cyan pigments and cyan dyes such as copper phthalocyanine compounds and derivatives thereof; anthraquinone compounds; and basic dye lake compounds.

Concrete examples include C. I. Pigment Blue 1, 7, 15, 15:1, 15:2, 15:3, 15:4, 60, 62 and 66.

The content of the colorant is preferably from 1.0 part by mass to 20.0 parts by mass relative to 100.0 parts by mass of the binder resin.

The toner particle can be made into a magnetic toner by having a magnetic body incorporated thereinto.

In this case the magnetic body can also serve as a colorant.

Examples of magnetic bodies include iron oxides typified by magnetite, hematite and ferrite; and metals such as iron, cobalt and nickel, and alloys of these metals with metals such as aluminum, cobalt, copper, lead, magnesium, tin, zinc, antimony, beryllium, bismuth, cadmium, calcium, manganese, selenium, titanium, tungsten or vanadium, as well as mixtures of the foregoing.

The content of the magnetic body in a case where one such is used as a colorant, is preferably from 20.0 to 120.0 parts by mass relative to 100.0 parts by mass of the binder resin.

### Charge Control Agent

The toner may contain a charge control agent. A known charge control agent can be used, without particular limitations, as the charge control agent.

Concrete examples of negative charge control agents include metal compounds of aromatic carboxylic acids such as salicylic acid, alkyl salicylic acids, dialkyl salicylic acids, naphthoic acid and dicarboxylic acids, and polymers and copolymers of metal compounds of these aromatic carboxylic acids; polymers or copolymers having a sulfonic acid group, a sulfonic acid base or a sulfonic acid ester group; metal salts or metal complexes of azo dyes or azo pigments; as well as boron compounds, silicon compounds and calixarenes.

Examples of positive charge control agents include quaternary ammonium salts; polymer compounds having a quaternary ammonium salt in a side chain; guanidine compounds; nigrosin-based compounds and imidazole compounds.

Examples of polymers or copolymers having sulfonic acid groups or sulfonic acid ester groups include homopolymers of sulfonic acid group-containing vinylic monomers such as styrene sulfonic acid, 2-acrylamide-2-methylpropane sulfonic acid, 2-methacrylic amide-2-methylpropane sulfonic acid, vinylsulfonic acid and methacrylic sulfonic acid, and copolymers of such sulfonic acid group-containing vinylic monomers with other known vinylic monomers.

The content of the charge control agent is preferably from 0.01 parts by mass to 5.0 parts by mass relative to 100.0 parts by mass of the binder resin.

### External Additive

The toner comprises an external additive. The external additive comprises a fatty acid metal salt particle. In addition to the fatty acid metal salt particle, the external additive may contain external additives other than the fatty acid metal salt particle,

Any known external additive can be used, without particular limitations, as the external additive.

Specific examples include starting silica fine particles such as wet-produced silica or dry-produced silica, and surface-treated silica fine particles resulting from subjecting such starting silica fine particles to a surface treatment using a treating agent such as a silane coupling agent, a titanium coupling agent or silicone oil; as well as resin fine particles such as vinylidene fluoride fine particles and polytetrafluoroethylene fine particles.

The content of external additive is preferably from 0.1 to 5.0 parts by mass relative to 100.0 parts by mass of toner particle.

A method for obtaining the toner of the present disclosure will be explained in detail next.

### Method for Producing a Toner Particle

The method for producing the toner particle is not particularly limited, and for instance an emulsification aggregation method, a suspension polymerization method, a dissolution suspension method or a pulverization method can be resorted to. An emulsification aggregation method is preferably resorted to among the foregoing. That is, the toner particle is preferably an emulsification-aggregation toner particle. An emulsification-aggregation toner particle has moderate unevenness on the surface, and as a result cleaning performance and transferability that such a toner particle affords are excellent. Also the dispersibility of the fatty acid metal salt particle is readily increased.

The emulsification aggregation method involves firstly preparing a dispersion of fine particles of a binder resin, and preparing dispersions of respective materials such as a colorant or release agent, as needed. A dispersion stabilizer is added, as needed, to the obtained dispersions of the respective materials, with dispersion and mixing of the whole. A flocculant is added thereafter to thereby elicit aggregation up to a desired particle size of the toner particle, whereupon the resin fine particles are caused to fuse together, thereafter or simultaneously with aggregation. A toner particle is then formed through shape control by heating, as needed.

The toner production method preferably includes the following steps.

(1) A dispersion mixing step of preparing a binder resin fine particle dispersion (colorant fine particle dispersion or the like, as needed) containing a binder resin and fumaric acid, and mixing the whole, to yield a mixed dispersion.

(2) An aggregation step of forming aggregates through aggregation of binder resin fine particles (colorant fine particles or the like, as needed) contained in the obtained mixed dispersion.

(3) A fusion step of thermally fusing the aggregates, to form fused particles.

A toner particle can then be obtained through cooling of the obtained fused particles.

Preferably, step (4) below is included in step (3) above, or after steps (1) to (3) above.

(4) A spheroidizing step of further heating the aggregates by raising the temperature thereof.

More preferably, steps (5) and (6) below are included, in this order, after step (4) above.

(5) A cooling step of cooling the aggregates at a cooling rate of 0.1° C./min or higher.

(6) An annealing step of, after the cooling step, maintaining heating at a temperature equal to or higher than the crystallization temperature or equal to or higher than the glass transition temperature of the binder resin.

Herein, the fine particles of the binder resin may also be configured as composite particles formed out of a plurality of layers in the form of two or more layers of resins having different compositions. For instance the binder resin fine particles can be produced in accordance with at least one method selected from the group consisting of emulsion polymerization, miniemulsion polymerization and phase inversion emulsification.

In a case where an internal additive is to be incorporated into the toner particle, the internal additive may be incorporated in the resin fine particles, or a dispersion of internal additive fine particles containing the internal additive may be prepared separately, whereupon the internal additive fine particles may be caused to aggregate with resin fine particles.

A toner particle exhibiting a layer build-up having dissimilar compositions can be produced by eliciting particle aggregation through time-lagged addition of resin fine particles having different compositions. That is, a toner particle having a core-shell structure can also be produced. After a core has been formed through aggregation of the resin fine particles containing a binder resin, resin fine particles containing a shell resin are added, with a time lag, to elicit aggregation and form a shell as a result.

The shell resin may be the same resin as the binder resin, or may be a different resin. For instance the shell resin can contain fumaric acid. The resin fine particles containing the shell resin may contain fumaric acid. The addition amount of the shell resin (shell content) is preferably from 1.0 to 10.0 parts by mass, more preferably from 2.0 to 7.0 parts by mass, relative to 100 parts by mass of the binder resin contained in the core particles.

Preferably, the method for producing a toner particle having a core-shell structure has the steps below. The method preferably has the following steps in the order below.

(1) A dispersion step of preparing dispersions (a colorant fine particle dispersion, as needed) of binder resin fine particles having a binder resin and fumaric acid, and mixing the dispersions, to yield a mixed dispersion.

(2) An aggregation step of forming aggregates through aggregation of binder resin fine particles (for instance colorant fine particles, as needed) contained in the obtained mixed dispersion.

(3) A shell forming step of further adding resin fine particles containing a shell resin to the dispersion containing the aggregates, and aggregating the resin fine particles, to form aggregates having a shell.

(4) A fusion step of fusing the aggregates through heating, to form fused particles.

Preferably, step (5) below is included in step (4) above, or after steps (1) to (4) above.

(5) A spheroidizing step of further heating the aggregates by raising the temperature thereof.

More preferably, steps (6) and (7) below are included, in this order, after step (5) above.

(6) A cooling step of cooling the aggregates at a cooling rate of 0.1° C./sec or higher.

(7) An annealing step of, after the cooling step, maintaining heating at a temperature equal to or higher than the crystallization temperature or equal to or higher than the glass transition temperature of the binder resin.

The addition amount of fumaric acid is not particularly limited, but is preferably from 0.006 to 0.500 parts by mass, more preferably from 0.006 to 0.400 parts by mass, and yet more preferably from 0.006 to 0.200 parts by mass, relative to 100 parts by mass of the binder resin. The content a of fumaric acid in the toner can be suitably adjusted by virtue of the fact that the addition amount of fumaric acid lies within the above ranges.

The addition amount of the fatty acid metal salt particle is not particularly limited, but is preferably from 0.003 to 0.700 parts by mass, more preferably from 0.005 to 0.600 parts by mass, and yet more preferably from 0.005 to 0.500 parts by mass, relative to 100 parts by mass of the toner particle. The content b of the fatty acid metal salt particle in the toner can be suitably adjusted by virtue of the fact that the addition amount of the fatty acid metal salt particle lies within the above ranges.

The following can be used as a dispersion stabilizer.

A surfactant can be used as a dispersion stabilizer. Known cationic surfactants, anionic surfactants and nonionic surfactants can be used as the surfactant.

Examples of inorganic dispersion stabilizers include tricalcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica and alumina.

Examples of organic dispersion stabilizers include polyvinyl alcohol, gelatin, methyl cellulose, methyl hydroxypropyl cellulose, ethyl cellulose, sodium carboxymethyl cellulose and starch.

The foregoing may be used singly, or alternatively two or more types of the foregoing may be used concomitantly.

As the flocculant there can be used a surfactant having a polarity opposite to that of the surfactant used as the above dispersion stabilizer, and also inorganic salts and divalent or higher inorganic metal salts. In particular, inorganic metal salts are preferable, as these allow readily controlling aggregation properties and controlling the toner charging performance through ionization of a polyvalent metal element in an aqueous medium.

Concrete examples of preferred inorganic metal salts include metal salts such as calcium chloride, calcium nitrate, barium chloride, magnesium chloride, zinc chloride, iron chloride, aluminum chloride and aluminum sulfate, as well as inorganic metal salt polymers such as polyferric chloride, polyaluminum chloride, polyaluminum hydroxide and calcium polysulfide. Particularly preferred among the foregoing are aluminum salts and polymers thereof. The foregoing may be used singly, or alternatively two or more types of the foregoing may be used concomitantly.

In order to obtain a sharper particle size distribution, ordinarily, the valence of the inorganic metal salt is preferably divalent rather than monovalent, and trivalent or higher rather than divalent: for a same valence, polymers of inorganic metal salts are more preferable.

From the viewpoint of high definition and high resolution of the image, the weight-average particle diameter (D4) of toner particle is preferably from 3.0 to 10.0 μm.

From the viewpoint of striking a balance between developing performance, transferability and cleaning performance, the average circularity of the toner particle may be from 0.940 to 0.980, and is preferably from 0.950 to 0.980, and more preferably from 0.955 to 0.970. By controlling average circularity so as to lie within the above ranges, the fatty acid metal salt can be readily distributed uniformly on the toner. Accordingly, the uniformity of the image surface after image rubbing improves, and it becomes possible to achieve an image exhibiting higher gloss, even after the rubbing. The fatty acid metal salt is stably supplied from the toner to the cleaning blade, and the cleaning performance of the external additive improves yet further.

### Toner Production Method

A toner can be obtained by mixing an external additive containing a fatty acid metal salt particle with the toner particle obtained above, and by causing the resulting mixture to adhere to the surface of the toner particle. The toner production method includes an external addition step of externally adding an external additive containing a fatty acid metal salt particle to the toner particle. An external additive other than the above-described fatty acid metal salt particle may be added at this time, as needed.

The mixing equipment for external addition of the external additive to the toner particle is not particularly limited, and any known mixing equipment, whether of dry or wet type, can be used herein. Examples include FM mixer (by Nippon Coke & Engineering Co., Ltd.), Super Mixer (by Manufacturing Co., Ltd.), Nobilta (by Hosokawa Micron Corporation), and Hybridizer (by Nara Machinery Co., Ltd.). The toner can be prepared by adjusting the rotational speed of the external addition device, the treatment time, and the water temperature and water amount in a jacket.

Examples of sifting devices used for sifting coarse particles after external addition include Ultrasonic (by Koei Sangyo Co., Ltd.); Resona Sieve and Gyro Shifter (by Tokuju Co., Ltd); Vibrasonic System (by Dalton Co., Ltd.); Soniclean (by Sintokogio, Ltd.); Turbo Screener (by Turbo Kogyo Ltd.); and Micro Shifter (by Makino Sangyo Ltd.).

Methods for measuring the physical properties of the toner and various materials will be explained below.

Method for Measuring the Content a (mol/g) of Fumaric Acid in the Toner

Herein 0.1 g of toner are added to 1 ml of chloroform. Then 20 ml of methanol are added dropwise onto the obtained sample solution, to elicit precipitation of a resin fraction in the solution, after which the solids fraction is removed by centrifugation (model: HITACHI himac CR22G, conditions: 12000 rpm, 10 minutes). The solvent is distilled off, under reduced pressure, from the resulting solution, with further drying under reduced pressure in a 60° C. atmosphere for 4 hours. Then 0.5 mL of BSTFA (N,O-bis(trimethylsilyl)trifluoroacetamide) and 0.5 mL of acetonitrile are added to the obtained sample, with heating at 80° C. for 1 hour, to thereby carry out a silylation treatment. The obtained sample is analyzed by GC-MS (gas chromatography mass spectrometry).

The measurement conditions are specifically as follows.
GCMS equipment: Trace1310 (by Thermo Fisher Scientific Inc.), ISQ (by Thermo Fisher Scientific Inc.)
Column: HP-5 ms 30 m
Inlet temperature: 250° C.
Injection amount: 1 μL
Column oven temperature: from 40° C. to 300° C. (15° C./min)
MS ionization mode: EI
Ion source temperature: 250° C.
Mass range: 35-800 m/z

The presence or absence of fumaric acid contained in the sample can be determined by analyzing in turn the profile obtained as a result of the above analysis, comparing peak positions of the measurement sample with respective peak positions of a profile obtained from a fumaric acid standard, and by checking mass spectra.

In parallel, there are prepared several samples (for instance of 100 ng, 200 ng and 300 ng) resulting from weighing exactly only a fumaric acid standard, such that prior to measurement of a sample obtained from toner, there are performed respective measurements under the above analysis conditions, after which a calibration curve is created from the inputted amounts of fumaric acid and the peak area values of fumaric acid.

The content a (mol/g) of fumaric acid in the toner is determined by converting the surface area value of the fumaric acid component of the toner to the mass of fumaric acid on the basis of this calibration curve, with further conversion to number of moles referred to toner mass.

### Method for Identifying Fatty Acid Metal Salt Particle

Identification of the fatty acid metal salt can be accomplished by combining shape observation using a scanning electron microscope (SEM) and elemental analysis by energy-dispersive X-ray spectroscopy (EDS).

The toner is observed in a field of view magnified up to a maximum of 50000 magnifications using a scanning electron microscope “S-4800” (product name; by Hitachi, Ltd.). The external additive to be discriminated is observed through focusing onto the toner particle surface. Then the external additive to be discriminated is subjected to EDS analysis, whereupon a fatty acid metal salt can be identified on the basis of the presence or absence of element peaks. A fatty acid metal salt can be inferred by analogy to be present in a case where there is observed an element peak of a metal capable of forming a fatty acid metal salt, for instance at least one metal selected from the group consisting of for instance Mg, Zn, Ca, Al, Na and Li.

A standard of the fatty acid metal salt having thus inferred by EDS analysis is prepared separately, and shape observation by SEM and EDS analysis are carried out. The fatty acid metal salt is identified as a result of a comparison to the effect of whether the analysis result of the standard matches or not the analysis result of the particles to be discriminated.

Method for Measuring the Content b (mol/g) of Fatty Acid Metal Salt Particle in the Toner

The amount of the metal ascertained in the fatty acid metal salt identification method (hereafter also referred to as metal to be measured) is measured using a wavelength-dispersive X-ray fluorescence analyzer. Specifically, 4 g of the toner below are prepared and are pelletized, and the content of the metal to be measured is worked out.

The following operation is performed first, for the purpose of classifying the metal to be measured into a metal derived from a fatty acid metal salt particle that is externally added to toner, and a metal derived from toner particle.

Firstly there are prepared: (1) toner as-is; (2) toner having passed five times through a sieve having a mesh opening of 38 μm (400 mesh), and (3) toner having passed 20 times through a sieve having a mesh opening of 38 μm (400 mesh). The toners (1), (2) and (3) are each measured using a wavelength-dispersive X-ray fluorescence analyzer as described below.

A fatty acid metal salt particle having been externally added to the toner sloughs off as the toner passes through the sieve, such that the amount of the sloughed fatty acid metal salt particle increases with increasing number of passes through the sieve. Accordingly, the content of metal in the toner (2) is lower than that in (1), and the content of metal in toner (3) is lower than that in (2). The content of metal derived from the toner particle can then be determined, by extrapolation, in a graph created in accordance with the below-described method. The content is calculated on the basis of only the measured value in (1) above, in a case where the metal is present only in the fatty acid metal salt particle.

The measurement using the wavelength-dispersive X-ray fluorescence analyzer conforms to JIS K 0119-1969, and involves specifically the following.

The measuring device utilized herein is a wavelength-dispersive X-ray fluorescence analyzer “Axios” (by PANalytical B. V.), with ancillary dedicated software “SuperQ ver. 5.0 L” (by PANalytical B. V.), Rhodium (Rh) is used as the anode of the X-ray tube, the measurement atmosphere is vacuum, and the measurement diameter (collimator mask diameter) is set to 27 mm

The measurement involves measuring a range from F to U in accordance with the Omnian method, using a proportional counter (PC) to measure light elements and a scintillation counter (SC) to measure heavy elements. The acceleration voltage and current value of the X-ray generator are set to yield an output of 2.4 kW. Herein 4 g of the above toner sample are placed in a dedicated aluminum ring for pressing, and the toner is smoothed over; then the measurement sample to be used is obtained in the form of a pellet shaped to a thickness of about 2 mm and a diameter of about 39 mm through pressing for 60 seconds at 20 MPa using a tablet compression molder “BRE-32” (by Maekawa Testing Machine Mfg. Co., Ltd.).

The measurement is carried out under the above conditions, whereupon elements are identified on the basis of the obtained X-ray peak positions; element mass ratios are calculated from a count rate (units: cps) which is the number of X-ray photons per unit time.

The analysis involves working out the content of metals in the toner by calculating a mass ratio of all the elements contained in the sample, in accordance with a FP (fundamental parameter) quantitative method. In the FP quantitative method a balance is set that conforms to the binder resin of the toner.

For the corresponding metals in each of toners (1), (2) and (3) above as determined by X-ray fluorescence, and with A as the quantitative value of (1), B as the quantitative value of (2) and C as the quantitative value of (3), a graph is created where the horizontal axis is the ratio of measured values relative to A, and the vertical axis are the respective measured values. Specifically, there are plotted (horizontal axis, vertical axis)=(A/A=1, A), (B/A, B), (C/A, C), and an approximate straight line is created in accordance with a least squares method. Assuming that the intercept of the approximate straight line is a metal derived from the toner particle, the content of metal derived from the fatty acid metal salt particle externally added to the toner can be worked out by deriving the difference between the value of A and the value of the intercept of the approximate straight line.

The content (g) of the fatty acid metal salt particle in the toner can then be worked out using the above measured metal content as the metal that is a main component of a fatty acid metal salt, such as a stearic acid metal salt. Specifically, the measured content (g) is converted into content (mol) by being divided by the molecular weight of the fatty acid metal salt having been identified in accordance with the above-described method for identifying the fatty acid metal salt particle.

The content b (mol/g) of the fatty acid metal salt particle in the toner can be obtained by converting the obtained content (mol) into an amount referred to toner mass (g).

Further, a/b is calculated using the values of a and b obtained above.

### Identification of Release Agent in the Toner

(1) Method of Separating the Release Agent from the Toner

Firstly, the melting point of the release agent in the toner is measured using a thermal analyzer (DSC Q2000 by TA Instruments Inc. Japan Co., Ltd.).

Herein 3.0 mg of a toner sample are disposed on a sample container in the form of an aluminum-made pan (Kit no. 0219-0041), the sample container is placed on a holder unit, and the holder unit is set in an electric furnace. The sample is heated from 30° C. to 200° C. at a ramp rate of 10° C./min in a nitrogen atmosphere, the resulting DSC curve is measured using a differential scanning calorimeter (DSC), and the melting point of the release agent in the toner sample is calculated.

The toner is subsequently dispersed in ethanol, which is a poor solvent of toner, and the temperature is raised up to a temperature exceeding the melting point of the release agent. Pressure may be applied at that time, as needed. The release agent exceeding the melting point thereof melts, and becomes extracted into ethanol, as a result of this operation. Through heating with further application of pressure, the release agent can thereupon be separated from the toner by solid-liquid separation while maintaining the applied pressure as-is. The release agent is then obtained by drying and solidifying the resulting extract.

### (2) Identification of the Release Agent by Pyrolysis GCMS

Concrete conditions for identifying a release agent by pyrolysis GCMS are set out below.

Mass spectrometer: ISQ by Thermo Fisher Scientific Inc.

GC device: Focus GC by Thermo Fisher Scientific Inc.

Ion source temperature: 250° C.

Ionization method: EI

Mass range: 50-1000 m/z

Column: HP-5 MS (30 m)

Pyrolysis device: JPS-700 by Japan Analytical Industry Co., Ltd.

The release agent separated as a result of an extraction operation is added to 1 mass % of tetramethylammonium hydroxide (TMAH), in pyrofoil at 590° C., to yield a measurement sample. A pyrolysis GCMS measurement is performed, under the above conditions, on 1 μL of the produced sample, to obtain peaks derived from the release agent.

Respective peaks for an alcohol component and a carboxylic acid component are obtained in a case where the release agent is an ester compound. The alcohol component and the carboxylic acid component are detected in the form of methylated products resulting from the action of TMAH, which is a methylating agent. The structure of the release agent can be then identified by analyzing the obtained peaks. Also the molecular weight of the release agent can also be obtained by identifying the structure of the release agent. In a case where the release agent exhibits a distribution in molecular weight, for instance in the case of a hydrocarbon wax, the molecular weight of the most commonly detected component is taken as the molecular weight of the wax.

### Method for Measuring the Melting Point

The melting point of a crystalline material (crystalline resin or release agent such as wax) is measured using a differential scanning calorimeter (DSC) Q2000 (by TA Instruments Inc.) under the following conditions.
Ramp rate: 10° C./min
Measurement start temperature: 20° C.
Measurement end temperature: 180° C.

The melting points of indium and zinc are used for temperature correction in the detection unit of the device, and the heat of fusion of indium is used for correcting the amount of heat.

Specifically, about 5 mg of sample are weighed exactly, are placed on an aluminum-made pan, and a measurement is performed once. An empty pan made up of aluminum is used as a reference. The peak temperature of the maximum endothermic peak at this time is taken as the melting point.

### Method for Measuring the Glass Transition Temperature (Tg) of the Binder Resin

The glass transition temperature (Tg) of the binder resin is measured according to ASTM D3418-82 using a differential scanning calorimeter “Q1000” (by TA Instruments Inc.).

The temperature at the detection unit of the device is corrected on the basis of the melting points of indium and zinc, and the amount of heat is corrected on the basis of the heat of fusion of indium. Specifically, 5 mg of binder resin are weighed exactly, and are placed on a pan made of aluminum; a measurement is then carried out at a ramp rate of 1° C./min within a measurement range from 30 to 200° C., using an empty aluminum-made pan as a reference. In this temperature raising process there is obtained a specific heat change within a temperature range from 40° C. to 100° C. The intersection between a differential heat curve and a midpoint line of a baseline before and after a change in specific heat at this time is taken as the glass transition temperature (Tg) of the binder resin.

### Method for Measuring Average Circularity

The average circularity of toner and of a toner particle is measured and analyzed under the conditions below using a flow particle image analyzer “FPIA-3000” (by Sysmex Corporation).

The concrete measurement method is as follows. Firstly, about 20 mL of ion-exchanged water having had solid impurities and so forth removed therefrom beforehand are placed in a glass vessel. Then about 0.2 mL of a dilution containing a dispersing agent in the form of “Contaminon N” (10 mass % aqueous solution of a pH 7 neutral detergent for cleaning of precision instruments, containing a nonionic surfactant, an anionic surfactant and an organic builder, by Wako Pure Chemical Industries, Ltd.) diluted thrice by mass in ion-exchanged water, is added to the glass vessel. Further, about 0.02 g of measurement sample are added and are dispersed for 2 minutes using an ultrasonic disperser, to prepare a dispersion for measurement. The dispersion is cooled as appropriate down to a temperature from 10° C. to 40° C.

The ultrasonic disperser that is used is a desktop ultrasonic cleaner/disperser (“VS-150” (by Velvo-Clear Co.)) having an oscillation frequency of 50 kHz and an electrical output of 150 W; herein, a given amount of ion-exchanged water is placed in the water tank, and about 2 mL of the above Contaminon N are added into the water tank.

In the measurement there is used a flow particle image analyzer fitted with “UPlanApro” (10 magnifications; numerical aperture 0.40), as an objective lens; further, Particle Sheath “PSE-900A” (by Sysmex Corporation) is used as a sheath solution.

A dispersion prepared in accordance with the above procedure is introduced to the flow particle image analyzer, and 3000 toner particles are measured according to a total count mode, in an HPF measurement mode. The average circularity of the toner particle is then worked out with a binarization threshold at the time of particle analysis set to 85%, and with the analyzed particle diameter limited to a circle-equivalent diameter in the range from 1.985 μm to less than 39.69 μm.

Automatic focus adjustment is performed, before the start of the measurement, using standard latex particles (dilution of “RESEARCH AND TEST PARTICLES Latex Microsphere Suspensions 5200A”, by Duke Scientific Corporation, in ion-exchanged water).

### Method for Measuring the Weight-Average Particle Diameter (D4)

The weight-average particle diameter (D4) of toner, or a toner particle (hereafter also referred to as toner etc.) is calculated as follows.

The measuring device used herein is a precision particle size distribution measuring device “Coulter Counter Multisizer 3” (registered trademark, by Beckman Coulter, Inc.) relying on a pore electrical resistance method and equipped with a 100 μm aperture tube.

Measurement conditions are set, and measurement data analyzed, using dedicated software (Beckman Coulter Multisizer 3, Version 3.51”, by Beckman Coulter, Inc.) ancillary to the device. The measurements are performed in 25,000 effective measurement channels.

An electrolytic aqueous solution that can be used in the measurements results from dissolution of special-grade sodium chloride to a concentration of about 1.0% in ion-exchanged water, and may be for instance “ISOTON II” (by Beckman Coulter, Inc.).

The dedicated software is set up as follows, prior to measurement and analysis.

In the screen of “Modification of the Standard Measurement Method (SOMME)” of the dedicated software, a Total Count of the Control Mode is set to 50000 particles, the number of measurements is set to one, and a Kd value is set to a value obtained using “Standard particles 10.0 μm” (by Beckman Coulter Inc. The “Threshold/Noise Level Measurement Button” is pressed, to thereby automatically set a threshold value and a noise level. Then the current is set to 1600 μA, the gain is set to 2, the electrolytic aqueous solution is set to ISOTON II, and “Flushing of the Aperture Tube Following Measurement” is ticked.

In the screen for “Setting of Conversion from Pulses to Particle Diameter” of the dedicated software, the Bin Interval is set to a logarithmic particle diameter, the Particle Diameter Bin is set to 256 particle diameter bins, and the Particle Diameter Range is set to a range from 2 μm to 60 μm.

The concrete measuring method is as follows.

(1) Herein 200.0 mL of the electrolytic aqueous solution are placed in a dedicated 250 mL round-bottomed glass beaker ancillary to Multisizer 3, and the beaker is set on a sample stand and is stirred counterclockwise with a stirrer rod at 24 rotations/second. Dirt and air bubbles are then removed from the aperture tube by way of the “Aperture Flush” function of the dedicated software.

(2) Then about 30.0 mL of the electrolytic aqueous solution are placed in a 100 mL flat-bottomed glass beaker. To the beaker there is added a dispersing agent in the form of 0.3 mL of a dilution of “Contaminon N” (10 mass % aqueous solution of a pH-7 neutral detergent for precision measuring instruments, made up of a nonionic surfactant, an anionic surfactant and an organic builder, by Wako Pure Chemical Industries, Ltd.), diluted thrice by mass in ion-exchanged water.

(3) An ultrasonic disperser is prepared having an electrical output of 120 W, “Ultrasonic Dispersion System Tetora 150” (by Nikkaki Bios Co., Ltd.), internally equipped with two oscillators that oscillate at a frequency of 50 kHz and are disposed at phases offset by 180 degrees. Then 3.3 L of ion-exchanged water are charged into a water tank of the ultrasonic disperser, and 2.0 mL of Contaminon N are added to the water tank.

(4) The beaker in (2) is set in a beaker-securing hole of the ultrasonic disperser, which is then operated. The height position of the beaker is adjusted so as to maximize a resonance state at the liquid surface of the electrolytic aqueous solution in the beaker.

(5) With the electrolytic aqueous solution in the beaker of (4) being ultrasonically irradiated, about 10 mg of the toner or the like are then added little by little to the electrolytic aqueous solution, to be dispersed therein. The ultrasonic dispersion treatment is further continued for 60 seconds. The water temperature in the water tank during ultrasonic dispersion is adjusted as appropriate so as to range from 10° C. to 40° C.

(6) The electrolytic aqueous solution in (5) having the toner or the like dispersed therein is added dropwise, using a pipette, to the round-bottomed beaker of (1) set in the sample stand, and the measurement concentration is adjusted to about 5%. A measurement is then performed until the number of measured particles reaches 50000.

(7) Measurement data is analyzed using the dedicated software ancillary to the apparatus, to calculate the weight-average particle diameter (D4). The “Average Diameter” in the “Analysis/Volume Statistics (arithmetic mean)” screen, with Graph/volume % set in the dedicated software, yields herein the weight-average particle diameter (D4).

### Median Diameter of the Fatty Acid Metal Salt Particle

The volume-basis median diameter of the fatty acid metal salt particle is measured in accordance with JIS Z8825-1 (2001), specifically in the manner below. The measuring device used herein is a laser diffraction/scattering particle size distribution measuring device “LA-920” (by Horiba Ltd.). Dedicated software “HORIBA LA-920 for Windows (registered trademark) WET (LA-920) Ver. 2.02”, ancillary to LA-920, is used for setting measurement conditions and analyzing measurement data. Ion-exchanged water having had for instance solid impurities removed therefrom beforehand is used as the measurement solvent.

The measurement procedure is as follows.

(1) A batch cell holder is attached to LA-920.

(2) A specific amount of ion-exchanged water is added to a batch cell, and the batch cell is set in the batch cell holder.

(3) The interior of the batch cell is stirred using a dedicated stirrer tip.

(4) The “Refractive index” button is on the “Display condition settings” screen is pressed, and file “110A000I” (relative refractive index 1.10) is selected.

(5) The particle diameter basis is set to volume base on the “Display condition settings” screen.

(6) A warm-up operation is carried out for at least one hour, followed by optical axis adjustment, optical axis fine-tuning and blank measurement.

(7) Then about 60 ml of ion-exchanged water are placed a 100 ml flat-bottom glass beaker. To the beaker there is added a dispersing agent in the form of 0.3 ml of a dilution of “Contaminon N” (10 mass % aqueous solution of a pH-7 neutral detergent for precision measuring instruments, made up of a nonionic surfactant, an anionic surfactant and an organic builder, by Wako Pure Chemical Industries, Ltd.), diluted thrice by mass in ion-exchanged water.

(8) An ultrasonic disperser is prepared that has an electrical output of 120 W “Ultrasonic Dispersion System Tetora 150” (by Nikkaki Bios Co., Ltd.), internally equipped with two oscillators that oscillate at a frequency of 50 kHz and are disposed at phases offset by 180 degrees. Then about 3.3 L of ion-exchanged water are charged into the water tank of the ultrasonic disperser, and about 2 mL of Contaminon N are added to the water tank.

(9) The beaker in (7) is set in a beaker-securing hole of the ultrasonic disperser, which is then operated. The height position of the beaker is adjusted so as to maximize a resonance state at the liquid surface of the aqueous solution in the beaker.

(10) With the aqueous solution in the beaker of (9) being ultrasonically irradiated, about 1 mg of the fatty acid metal salt particle is then added little by little to the aqueous solution in the beaker, to be dispersed therein. The ultrasonic dispersion treatment is further continued for 60 seconds. The fatty acid metal salt may at this time form clumps that float on the liquid surface; if that is the case, the beaker is shaken to submerge the clumps, after which ultrasonic dispersion is then performed for 60 seconds. The water temperature in the water tank during ultrasonic dispersion is adjusted as appropriate so as to range from 10° C. to 40° C.

(11) The aqueous solution having dispersed therein the fatty acid metal salt particle prepared in (10) is immediately added to the batch cell, little by little, while taking care that no air bubbles become entrained; the transmittance of a tungsten lamp is then adjusted to 90% to 95%. A particle size distribution is then measured. On the basis of the obtained volume-basis particle size distribution data there is calculated a 50% cumulative diameter.

### Identification and Quantification of the Binder Resin

Pyrolysis gas chromatography-mass spectrometry (hereafter also referred to as “Pyrolysis GC/MS”) and NMR are resorted to herein in order to identify the types of monomer units and the ratios of the monomer units in the binder resin. The types of constituent compounds of the resin are analyzed by pyrolysis GC/MS. The types of monomer units can be identified by analyzing the mass spectrum of the components of resin decomposition products generated upon pyrolysis of the resin at a temperature from 550° C. to 700° C. The concrete measurement conditions are as follows.

### Measurement Conditions for Pyrolysis GC/MS

Pyrolysis device: JPS-700 by Japan Analytical Industry Co., Ltd.

Decomposition temperature: 590° C.

GC/MS device: Focus GC/ISQ (by Thermo Fisher Scientific Inc.)

Column: HP-5 MS, length 60 m, inner diameter 0.25 mm, film thickness 0.25 μm

Inlet temperature: 200° C.

Flow pressure: 100 kPa

Split: 50 mL/min

MS ionization: EI

Ion source temperature: 200° C. Mass Range 45-650

The ratios of monomer units of the identified binder resin are measured/calculated next by ¹H-NMR. Structural determination is accomplished using an FT-NMR device JNM-EX400 (by JEOL Ltd.) (1H-NMR, 400 MHz, CDCl₃, room temperature (25° C.)).

### ¹H-NMR Measurement Conditions

Measurement frequency: 400 MHZ

Pulse conditions: 5.0 μs

Frequency range: 10500 Hz

Number of scans: 1024 scans

Measurement temperature: 25° C.

Sample: a sample is prepared by placing 50 mg of a measurement sample in a sample tube having an inner diameter of 5 mm, with addition of deuterated chloroform (CDCl₃) as a solvent, followed by dissolution in a thermostatic bath at 40° C.

The molar ratio of each monomer unit is determined from an integration value of the obtained spectrum, and thereupon the ratio (mass %) of each monomer unit is calculated on the basis of the respective molar ratio.

### Method for Measuring a Peak Molecular Weight (Mp)

The peak molecular weight (Mp) of the binder resin is measured by gel permeation chromatography (GPC), as follows. Firstly, a sample to be measured is dissolved in tetrahydrofuran (THF) at room temperature. If the sample appears not to dissolve readily, the sample is heated at or below 35° C. The obtained solution is then filtered through a solvent-resistant membrane filter “MYSYORI DISC” (by Tosoh Corporation) having a pore diameter of 0.2 μm, to yield a sample solution. The sample solution is adjusted so that the concentration of the THF-soluble fraction is about 0.8 mass %. A measurement is performed then under the conditions below, using the sample solution.
Device: High-speed GPC device “HLC-8220GPC” (by Tosoh Corporation)
Column: 2 columns LF-604 (by Showa Denko KK)
Eluent: THF
Flow rate: 0.6 mL/min
Oven temperature: 40° C.
Sample injection amount: 0.020 mL

To calculate the molecular weight of the sample there is used a molecular weight calibration curve created using a standard polystyrene resin (product name “TSK STANDARD POLYSTYRENE F-850, F-450, F-288, F-128, F-80, F-40, F-20, F-10, F-4, F-2, F-1, A-5000, A-2500, A-1000 or A-500”, by Tosoh Corporation).

### EXAMPLES

The present disclosure will be explained more specifically according to the below-described examples. However, the examples below are not meant to limit the present disclosure in any way. Unless particularly noted otherwise, the terms “parts” and “%” pertaining to the materials in the examples and comparative examples refer to mass basis in all instances.

### Production Example of a Polyester Resin

Polyester Resin 1

| Fumaric acid | 10.6 parts | (23 mol %) |
|---|---|---|
| Terephthalic acid | 8.5 parts | (13 mol %) |
| Trimellitic acid | 3.3 parts | (4 mol %) |
| Ethylene oxide 2-mole adduct of bisphenol A | 47.6 parts | (38 mol %) |
| Propylene oxide 2-mole adduct of bisphenol A | 30.0 parts | (22 mol %) |
| Dibutyltin oxide | 0.5 | parts |
| Hydroquinone | 0.05 | parts |

The above materials were charged into an autoclave equipped with a pressure reduction device, a water separation device, a nitrogen gas introduction device, a temperature measurement device and a stirring device; a reaction was conducted at 230° C. until the reaction rate reached 90%, after which the reaction was further conducted under reduced pressure of 60 to 70 mmHg, until the peak molecular weight reached 6000, to yield an amorphous Polyester resin 1.

The obtained Polyester resin 1 had an acid value of 20.3 mgKOH/g, a peak molecular weight (Mp) of 6000, a glass transition temperature of 54.6° C., and a solubility parameter of 21.01 ((J/cm³)^{1/2}).

Polyester Resin 2

| Terephthalic acid | 22.6 parts | (36 mol %) |
|---|---|---|
| Trimellitic acid | 3.2 parts | (4 mol %) |
| Ethylene oxide 2-mole adduct of Bisphenol A | 45.5 parts | (38 mol %) |
| Propylene oxide 2-mole adduct of bisphenol A | 28.7 parts | (22 mol %) |
| Dibutyltin oxide | 0.5 | parts |
| Hydroquinone | 0.05 | parts |

The above materials were charged into an autoclave equipped with a pressure reduction device, a water separation device, a nitrogen gas introduction device, a temperature measurement device and a stirring device; a reaction was conducted at 230° C. until the reaction rate reached 90%, after which the reaction was further conducted under reduced pressure of 60 to 70 mmHg, for 1 hour to yield an amorphous Polyester resin 2.

The obtained Polyester resin 2 had an acid value of 20.1 mgKOH/g, a peak molecular weight (Mp) of 6000, a glass transition temperature of 59.4° C. and a solubility parameter of 21.28 ((J/cm³)^{1/2}).

### Polyester Resin 3

An amorphous Polyester resin 3 was obtained similarly to the production example of Polyester resin 1, but herein the reaction in the production example of Polyester resin 1 was conducted until the peak molecular weight reached 12000.

The obtained Polyester resin 3 had an acid value of 12.2 mgKOH/g, a peak molecular weight (Mp) 12000, a glass transition temperature of 55.2° C., and a solubility parameter of 21.01 ((J/cm³)^{1/2}).

### Production Example of a Resin Particle Dispersion

Resin Particle Dispersion 1

| | | |
|---|---|---|
| Polyester resin 1 | 200 | parts |
| Ion-exchanged water | 500 | parts |
| Fumaric acid | 0.250 | parts |

The above materials were placed in a stainless steel container, and were melted through heating up to 95° C. in a warm bath, whereupon pH was adjusted be higher than 7.0 through addition of 0.1 mol/L sodium bicarbonate while under stirring at 7800 rpm using a homogenizer (Ultra-Turrax T50, by IKA KK). Thereafter, a mixed solution of 3 parts of sodium dodecylbenzenesulfonate and 297 parts of ion-exchanged water was gradually added dropwise, with emulsification and dispersion while under stirring at 7800 rpm, to yield Resin particle dispersion 1. The solids concentration of Resin particle dispersion 1 was 20%.

A measurement of the particle size distribution of the particles of Polyester resin 1 contained in Resin particle dispersion 1, using a particle diameter measuring device (LA-960V2, by Horiba, Ltd.), revealed that the number-average particle diameter of the particles of Polyester resin 1 was 0.25 μm, with no observable coarse particles exceeding 1 μm.

### Resin Particle Dispersions 2 to 11

Resin particle dispersions 2 to 11 were produced in the same way as in the production example of Resin particle dispersion 1 but herein modifying the resin that was used and the addition amount of fumaric acid in the production example of Resin particle dispersion 1 as given in Table 1. In resin particle dispersion 9, however, maleic acid was added instead of fumaric acid, in the amount given in Table 1. No coarse particles exceeding 1 μm were observed in any instance. Table 1 also sets out the number-average particle diameters of the polyester resin particles in Resin particle dispersions 2 to 11.

### Resin Particle Dispersion 12

Resin particle dispersion 12 having Vinyl resin 1 dispersed therein was produced in accordance with an emulsification aggregation method, as described below.

Herein 78.0 parts of styrene and 22.0 parts of butyl acrylate were placed in a stainless steel container and were mixed. To the resulting solution there was then added an aqueous solution resulting from mixing 4.0 parts of sodium dodecylbenzenesulfonate in 150 parts of ion-exchanged water, and the whole was dispersed. There was further added, while under stirring slow stirring for 10 minutes, an aqueous solution resulting from dissolving 0.3 parts of potassium persulfate in 10 parts of ion-exchanged water. The stainless steel container was purged with nitrogen, and thereafter emulsion polymerization was carried out at 70° C. for 6 hours. Once polymerization was over, the reaction solution was cooled down to room temperature, and ion-exchanged water was added, to adjust the solids concentration to 20.0 mass %.

A measurement of the particle size distribution of Resin particle dispersion 12, using a particle diameter measuring device (LA-960V2, by Horiba, Ltd.), revealed that the number-average particle diameter of the particles of Vinyl resin 1 was 0.25 μm, with no observable coarse particles exceeding 1 μm. A measurement of various physical properties of Vinyl resin 1 having been separated from the Resin particle dispersion 12 revealed that the acid value was 0.0 (mgKOH/g), the peak molecular weight was 20000 and the glass transition temperature was 54.0° C.

TABLE 1

| | | Addition amount of | |
|---|---|---|---|
| | | fumaric acid (parts | Number-average |
| | Resin | by mass) | particle diameter (μm) |
| Resin particle dispersion 1 | Polyester resin 1 | 0.2500 | 0.25 |
| Resin particle dispersion 2 | Polyester resin 1 | 0.1250 | 0.25 |
| Resin particle dispersion 3 | Polyester resin 1 | 0.0500 | 0.25 |
| Resin particle dispersion 4 | Polyester resin 1 | 0.0250 | 0.25 |
| Resin particle dispersion 5 | Polyester resin 1 | 0.3750 | 0.25 |
| Resin particle dispersion 6 | Polyester resin 1 | 0.3000 | 0.25 |
| Resin particle dispersion 7 | Polyester resin 1 | 0.0125 | 0.25 |
| Resin particle dispersion 8 | Polyester resin 2 | 0.0250 | 0.25 |
| Resin particle dispersion 9 | Polyester resin 2 | 0.2500 (Maleic acid) | 0.25 |
| Resin particle dispersion 10 | Polyester resin 2 | 0 | 0.25 |
| Resin particle dispersion 11 | Polyester resin 3 | 0.2500 | 0.25 |
| Resin particle dispersion 12 | Vinyl resin 1 | 0.0250 | 0.25 |

In the table, (Maleic acid) indicates that maleic acid was added, instead of fumaric acid, in the amount given in the table.

### Production Example of a Wax Particle Dispersion

### Wax Particle Dispersion 1

Wax Particle Dispersion 1

| | |
|---|---|
| Ion exchange water | 500 parts |
| Wax (FNP0090 (by Nippon Seiro | 200 parts |
| Co., Ltd.): Fischer-Tropsch hydrocarbon | |
| wax, melting point 90° C., molecular weight 771, | |
| solubility parameter: 17.16 (J/cm³)^{1/2}) | |

Wax (FNP0090 (by Nippon Seiro Co., Ltd.): Fischer-Tropsch hydrocarbon wax, melting point 90° C., molecular weight 771, solubility parameter: 17.16 (J/cm³)^{1/2}) 200 parts

The above materials were placed in a stainless steel container, and were melted through heating in a warm bath up to 95° C., whereupon pH was adjusted be higher than 7.0 through addition of 0.1 mol/L sodium bicarbonate while under stirring at 7800 rpm using a homogenizer (Ultra-Turrax T50, by IKA KK). Thereafter, a mixed solution of 5 parts of sodium dodecylbenzenesulfonate and 295 parts of ion-exchanged water was gradually added dropwise, with emulsification and dispersion while under stirring at 7800 rpm, to yield Wax particle dispersion 1. The solids concentration of Wax particle dispersion 1 was 20%.

A measurement of the particle size distribution of the wax particles in Wax particle dispersion 1, using a particle diameter measuring device (LA-960V2, by Horiba, Ltd.), revealed that the number-average particle diameter of the wax particles was 0.35 μm, with no observable coarse particles exceeding 1 μm.

### Wax Particle Dispersions 2 to 6

Wax particle dispersions 2 to 6 were produced in the same way as in the production example of Wax particle dispersion 1, but modifying herein the wax that was used in the production example of Wax particle dispersion 1 to that in Table 2.

TABLE 2

| | | | | | | Number-average |
|---|---|---|---|---|---|---|
| | | Melting | Molecular | SP | | particle diameter |
| | Wax type | point | weight | value | Classification | (μm) |
| Wax particle | FNP0090 | 90° C. | 771 | 17.16 | Fischer-Tropsch | 0.35 |
| dispersion 1 | | | | | hydrocarbon | |
| Wax particle | Pentaerythritol | 82° C. | 1426 | 18.15 | Tetrafunctional | 0.35 |
| dispersion 2 | tetrabehenate | | | | ester | |
| Wax particle | Dipentaerythritol | 73° C. | 1685 | 18.44 | Hexafunctional | 0.35 |
| dispersion 3 | hexapalmitate | | | | ester | |
| Wax particle | Behenyl behenate | 73° C. | 649 | 17.56 | Monofunctional | 0.35 |
| dispersion 4 | | | | | ester | |
| Wax particle | Behenyl stearate | 67° C. | 593 | 17.57 | Monofunctional | 0.35 |
| dispersion 5 | | | | | ester | |
| Wax particle | HNP-9 | 75° C. | 469 | 16.94 | Hydrocarbon | 0.35 |
| dispersion 6 | | | | | (paraffin) | |

### Production Example of a Colorant Particle Dispersion

| | | |
|---|---|---|
| Carbon black (Nipex 35: by Orion Engineered | 100 | parts |
| Carbons GmbH) | | |
| Sodium dodecylbenzenesulfonate | 5 | parts |
| Ion exchange water | 400 | parts |

The above materials were mixed and dispersed using a sand grinder mill, to obtain a colorant particle dispersion. The solids concentration of the colorant particle dispersion was 20%. A measurement of the particle size distribution of colorant particles contained in the colorant particle dispersion, using a particle diameter measuring device (LA-960V2, by Horiba, Ltd.), revealed that the number-average particle diameter of the colorant particles was 0.2 μm, with no observable coarse particles exceeding 1 μm.

### Production Example of a Toner Particle

Toner Particle 1

| | | |
|---|---|---|
| Resin particle dispersion 1 | 500 | parts |
| Colorant particle dispersion | 50 | parts |
| Wax particle dispersion 1 | 50 | parts |
| Sodium dodecylbenzenesulfonate | 5 | parts |

Resin particle dispersion 1, Wax particle dispersion 1 and sodium dodecylbenzenesulfonate were charged into a reactor (1-liter flask, anchor blade with baffles), with uniform mixing of the whole. Meanwhile, a colorant particle dispersion was uniformly mixed in a 500 mL beaker, and the resulting product was gradually added to the reactor, while under stirring, to obtain a mixed dispersion. While under stirring of the obtained mixed dispersion there were added dropwise 0.5 parts (solids) of an aqueous solution of aluminum sulfate, to form aggregated particles.

Once dropwise addition was over, the interior of the system was purged with nitrogen, was held at 50° C. for 1 hour, and was then held at 55° C. for a further 1 hour. The temperature was thereafter raised and held at 90° C. for 30 minutes. The temperature was subsequently lowered down to 63° C. and was held there for 3 hours, to form fused particles.

After having formed, the fused particles were cooled down to room temperature at a ramp down rate of 0.5° C. per minute.

After cooling, the reaction product was filtered through a 10 L pressure filter, and solid-liquid separation was carried out at a pressure of 0.4 MPa, to yield a toner cake. Ion-exchanged water was added thereafter until the pressure filter was full, with subsequent washing at a pressure of 0.4 MPa. The filter was further washed twice, in a similar manner, for a total of three washings. Then, after solid-liquid separation at a pressure of 0.4 MPa, the resulting product was subjected to fluidized bed drying at 45° C., to yield Toner particle 1 having a weight-average particle diameter (D4) of 6.9 μm and an average circularity of 0.960.

### Toner Particles 2 to 18

Toner particles 2 to 18 were produced in the same way as in the production example of Toner particle 1, but herein the resin particle dispersion and wax particle dispersion that were used were modified to those given in Table 3.

### Toner Particle 19

A pulverized toner was produced in accordance with the method described below.

| | | |
|---|---|---|
| Polyester resin 1 | 100.0 | parts |
| Fumaric acid | 0.125 | parts |
| Release agent (FNP0090) | 5.0 | parts |
| Colorant Nipex 35 (by Orion Engineered Carbons GmbH) | 5.0 | parts |

The above materials were pre-mixed using a Henschel mixer FM10C (by Nippon Coke & Engineering Co., Ltd. (formerly Mitsui Miike Machinery Co., Ltd.)), followed by melt-kneading using a twin-screw kneader (PCM-30 model, by Ikegai Corp.), to yield a kneaded product. The obtained kneaded product was cooled and was coarsely pulverized using a hammer mill (by Hosokawa Micron Corporation), followed by pulverization using a mechanical pulverizer (T-250, by Turbo Kogyo Co., Ltd.), to yield a finely pulverized powder. The obtained finely pulverized powder was classified using a multi-grade classifier relying on the Coanda effect (EJ-L-3 model, by Nittetsu Mining Co., Ltd.). to yield Toner particle 19 having a weight-average particle diameter (D4) of 6.9 μm and an average circularity of 0.940.

TABLE 3

| | | | | Weight-average | |
|---|---|---|---|---|---|
| | Resin particle | | Wax particle | particle diameter | Average |
| | dispersion | Binder resin | dispersion | (μm) | circularity |
| Toner particle 1 | Resin particle | Polyester | Wax particle | 6.9 | 0.960 |
| | dispersion 1 | resin 1 | dispersion 1 | | |
| Toner particle 2 | Resin particle | Polyester | Wax particle | 6.9 | 0.960 |
| | dispersion 1 | resin 1 | dispersion 2 | | |
| Toner particle 3 | Resin particle | Polyester | Wax particle | 6.9 | 0.960 |
| | dispersion 2 | resin 1 | dispersion 1 | | |
| Toner particle 4 | Resin particle | Polyester | Wax particle | 6.9 | 0.960 |
| | dispersion 3 | resin 1 | dispersion 1 | | |
| Toner particle 5 | Resin particle | Polyester | Wax particle | 6.9 | 0.960 |
| | dispersion 4 | resin 1 | dispersion 1 | | |
| Toner particle 6 | Resin particle | Polyester | Wax particle | 6.9 | 0.960 |
| | dispersion 8 | resin 2 | dispersion 1 | | |
| Toner particle 7 | Resin particle | Polyester | Wax particle | 6.9 | 0.960 |
| | dispersion 5 | resin 1 | dispersion 1 | | |
| Toner particle 8 | Resin particle | Polyester | Wax particle | 6.9 | 0.960 |
| | dispersion 6 | resin 1 | dispersion 1 | | |
| Toner particle 9 | Resin particle | Polyester | Wax particle | 6.9 | 0.960 |
| | dispersion 7 | resin 1 | dispersion 1 | | |
| Toner particle 10 | Resin particle | Polyester | Wax particle | 6.9 | 0.960 |
| | dispersion 2 | resin 1 | dispersion 2 | | |
| Toner particle 11 | Resin particle | Vinyl resin 1 | Wax particle | 6.9 | 0.960 |
| | dispersion 12 | | dispersion 2 | | |
| Toner particle 12 | Resin particle | Polyester | Wax particle | 6.9 | 0.960 |
| | dispersion 1 | resin 1 | dispersion 3 | | |
| Toner particle 13 | Resin particle | Polyester | Wax particle | 6.9 | 0.960 |
| | dispersion 1 | resin 1 | dispersion 4 | | |
| Toner particle 14 | Resin particle | Polyester | Wax particle | 6.9 | 0.960 |
| | dispersion 1 | resin 1 | dispersion 5 | | |
| Toner particle 15 | Resin particle | Polyester | Wax particle | 6.9 | 0.960 |
| | dispersion 1 | resin 1 | dispersion 6 | | |
| Toner particle 16 | Resin particle | Polyester | Wax particle | 6.9 | 0.960 |
| | dispersion 11 | resin 3 | dispersion 1 | | |
| Toner particle 17 | Resin particle | Polyester | Wax particle | 6.9 | 0.960 |
| | dispersion 10 | resin 1 | dispersion 3 | | |
| Toner particle 18 | Resin particle | Polyester | Wax particle | 6.9 | 0.960 |
| | dispersion 9 | resin 2 | dispersion 5 | | |
| Toner particle 19 | — | Polyester | — | 6.9 | 0.940 |
| | | resin 1 | | | |

### Production Example of Fatty Acid Metal Salt Particle

### Fatty Acid Metal Salt Particle 1

A receiving vessel equipped with a stirrer was prepared, and the stirrer was caused to rotate at 350 rpm. Then 500 parts of a 0.5 mass aqueous solution of sodium stearate as a fatty acid source was charged into this receiving vessel, and the liquid temperature was adjusted to 85° C. Then 525 parts of a 0.2 mass % aqueous solution of zinc sulfate as a metal source were added dropwise, over 15 minutes, into the receiving vessel. Once the entire amount was inputted, the resulting mixture was aged for 10 minutes at the temperature of the reaction, and the reaction was terminated.

The fatty acid metal salt slurry thus obtained was filtered and washed. The obtained washed fatty acid metal salt cake was coarsely pulverized and was dried at 105° C. using a continuous flash dryer. Thereafter, the resulting product was pulverized using a nano-grinding mill “NJ-300” (by Sunrex Kogyo Co., Ltd.) under conditions of air volume of 6.0 m³/min and processing speed of 80 kg/h, followed by re-slurrying and removal of fine particles and coarse particles using a wet centrifugal classifier. The product was dried at 80° C. using a continuous flash dryer, to yield Fatty acid metal salt particle 1. The volume-basis median diameter (D50s) of the obtained Fatty acid metal salt particle 1 was 0.45 μm.

### Fatty Acid Metal Salt Particles 2 to 8

Fatty acid metal salt particles 2 to 8 were produced as in the production example of Fatty acid metal salt 1, but modifying herein the fatty acid source and the metal source in the production example of the Fatty acid metal salt particle 1 to those given in Table 4.

TABLE 4

| | | | | | | | Volume-basis |
|---|---|---|---|---|---|---|---|
| | Substance | Fatty acid | Metal | Saturated/ | Fatty acid | SP | median diameter |
| | name | source | source | unsaturated | carbon number | value | (μm) |
| Fatty acid metal | Zinc | Sodium | Zinc | Saturated | 18 | 18.73 | 0.45 |
| salt particle 1 | stearate | stearate | sulfate | | | | |
| Fatty acid metal | Zinc | Sodium | Zinc | Saturated | 28 | 18.32 | 0.45 |
| salt particle 2 | montanate | montanate | sulfate | | | | |
| Fatty acid metal | Zinc | Sodium | Zinc | Saturated | 22 | 18.53 | 0.45 |
| salt particle 3 | behenate | behenate | sulfate | | | | |
| Fatty acid metal | Zinc | Sodium | Zinc | Saturated | 12 | 19.26 | 0.45 |
| salt particle 4 | laurate | laurate | sulfate | | | | |
| Fatty acid metal | Aluminum | Sodium | Aluminum | Saturated | 18 | 18.56 | 0.45 |
| salt particle 5 | stearate | stearate | chloride | | | | |
| Fatty acid metal | Aluminum | Sodium | Aluminum | Saturated | 8 | 19.32 | 0.45 |
| salt particle 6 | octylate | octylate | chloride | | | | |
| Fatty acid metal | Barium | Sodium | Barium | Saturated | 18 | 18.77 | 0.45 |
| salt particle 7 | stearate | stearate | chloride | | | | |
| Fatty acid metal | Barium | Sodium | Barium | Unsaturated | 18 | 20.67 | 0.45 |
| salt particle 8 | ricinoleate | ricinoleate | chloride | | | | |

### Production Example of a Toner

Toner 1

| | | |
|---|---|---|
| Toner particle 1 | 100.0 | parts |
| Fatty acid metal salt particle 1 | 0.200 | parts |
| Silica particles (RX200: primary average particle | 1.5 | parts |
| diameter 12 nm, HMDS-treated, by Nippon Aerosil | | |
| Co., Ltd.) | | |

The above materials were externally added and mixed using FM10C (by Nippon Coke & Engineering Co., Ltd.). The external addition conditions included: A0 blade as a lower blade, distance from deflector to wall set to 20 mm, input amount of 2.0 kg of the toner particle, rotational speed of 66.6 s⁻¹, external addition time of 10 minutes, cooling water temperature of 20° C., and flow rate of 10 L/min.

Thereafter, the product was sifted through a mesh having an opening of 37 μm, to obtain Toner 1. Tables 6-1 and 6-2, and Table 7 set out the physical properties of the obtained Toner 1.

### Toners 2 to 32

Toners 2 to 32 were produced as in the production example of Toner 1, but modifying herein the toner particle and the fatty acid metal salt particle in the production example of Toner 1 to those of Table 5, and modifying the amount of fatty acid metal salt particles as given in Table 5. Tables 6-1 and 6-2, and Table 7 set out the physical properties of the obtained Toners 2 to 32.

TABLE 5

| | | | Amount of fatty acid metal |
|---|---|---|---|
| | Toner particle | Fatty acid metal salt particle | salt particle (parts) |
| Toner 1 | Toner particle 1 | Fatty acid metal salt particle 1 | 0.200 |
| Toner 2 | Toner particle 2 | Fatty acid metal salt particle 1 | 0.200 |
| Toner 3 | Toner particle 3 | Fatty acid metal salt particle 1 | 0.200 |
| Toner 4 | Toner particle 4 | Fatty acid metal salt particle 1 | 0.100 |
| Toner 5 | Toner particle 5 | Fatty acid metal salt particle 1 | 0.100 |
| Toner 6 | Toner particle 6 | Fatty acid metal salt particle 1 | 0.100 |
| Toner 7 | Toner particle 7 | Fatty acid metal salt particle 1 | 0.200 |
| Toner 8 | Toner particle 8 | Fatty acid metal salt particle 1 | 0.200 |
| Toner 9 | Toner particle 9 | Fatty acid metal salt particle 1 | 0.050 |
| Toner 10 | Toner particle 2 | Fatty acid metal salt particle 1 | 0.600 |
| Toner 11 | Toner particle 2 | Fatty acid metal salt particle 1 | 0.500 |
| Toner 12 | Toner particle 10 | Fatty acid metal salt particle 1 | 0.010 |
| Toner 13 | Toner particle 10 | Fatty acid metal salt particle 1 | 0.005 |
| Toner 14 | Toner particle 2 | Fatty acid metal salt particle 2 | 0.100 |
| Toner 15 | Toner particle 2 | Fatty acid metal salt particle 3 | 0.100 |
| Toner 16 | Toner particle 2 | Fatty acid metal salt particle 4 | 0.100 |
| Toner 17 | Toner particle 2 | Fatty acid metal salt particle 5 | 0.100 |
| Toner 18 | Toner particle 2 | Fatty acid metal salt particle 6 | 0.100 |
| Toner 19 | Toner particle 2 | Fatty acid metal salt particle 7 | 0.100 |
| Toner 20 | Toner particle 2 | Fatty acid metal salt particle 8 | 0.100 |
| Toner 21 | Toner particle 11 | Fatty acid metal salt particle 1 | 0.100 |
| Toner 22 | Toner particle 12 | Fatty acid metal salt particle 1 | 0.100 |
| Toner 23 | Toner particle 13 | Fatty acid metal salt particle 1 | 0.100 |
| Toner 24 | Toner particle 14 | Fatty acid metal salt particle 1 | 0.100 |
| Toner 25 | Toner particle 15 | Fatty acid metal salt particle 1 | 0.200 |
| Toner 26 | Toner particle 16 | Fatty acid metal salt particle 1 | 0.200 |
| Toner 27 | Toner particle 19 | Fatty acid metal salt particle 1 | 0.200 |
| Toner 28 | Toner particle 17 | Fatty acid metal salt particle 1 | 0.200 |
| Toner 29 | Toner particle 5 | — | 0.000 |
| Toner 30 | Toner particle 5 | Fatty acid metal salt particle 1 | 0.200 |
| Toner 31 | Toner particle 18 | Fatty acid metal salt particle 1 | 0.200 |
| Toner 32 | Toner particle 3 | Fatty acid metal salt particle 1 | 0.003 |

TABLE 6-1

| | | | | | Fatty |
|---|---|---|---|---|---|
| | | | | Fatty acid | acid |
| | a | b | | saturated/ | carbon |
| | (mol/g) | (mol/g) | a/b | unsaturated | number |
| Toner 1 | 8.62E−06 | 3.16E−06 | 2.73 | Saturated | 18 |
| Toner 2 | 8.62E−06 | 3.16E−06 | 2.73 | Saturated | 18 |
| Toner 3 | 4.31E−06 | 3.16E−06 | 1.36 | Saturated | 18 |
| Toner 4 | 1.72E−06 | 1.58E−06 | 1.09 | Saturated | 18 |
| Toner 5 | 8.62E−07 | 1.58E−06 | 0.55 | Saturated | 18 |
| Toner 6 | 8.62E−07 | 1.58E−06 | 0.55 | Saturated | 18 |
| Toner 7 | 1.29E−05 | 3.16E−06 | 4.09 | Saturated | 18 |
| Toner 8 | 1.03E−05 | 3.16E−06 | 3.28 | Saturated | 18 |
| Toner 9 | 4.31E−07 | 7.90E−07 | 0.55 | Saturated | 18 |
| Toner 10 | 8.62E−06 | 9.43E−06 | 0.91 | Saturated | 18 |
| Toner 11 | 8.62E−06 | 7.87E−06 | 1.10 | Saturated | 18 |
| Toner 12 | 4.31E−06 | 1.58E−07 | 27.28 | Saturated | 18 |
| Toner 13 | 4.31E−06 | 7.91E−08 | 54.49 | Saturated | 18 |
| Toner 14 | 8.62E−06 | 2.19E−06 | 3.94 | Saturated | 28 |
| Toner 15 | 8.62E−06 | 2.67E−06 | 3.22 | Saturated | 22 |
| Toner 16 | 8.62E−06 | 4.30E−06 | 2.00 | Saturated | 12 |
| Toner 17 | 8.62E−06 | 3.27E−06 | 2.64 | Saturated | 18 |
| Toner 18 | 8.62E−06 | 6.04E−06 | 1.43 | Saturated | 8 |
| Toner 19 | 8.62E−06 | 2.83E−06 | 3.04 | Saturated | 18 |
| Toner 20 | 8.62E−06 | 2.73E−06 | 3.16 | Unsaturated | 18 |
| Toner 21 | 8.62E−07 | 1.58E−06 | 0.55 | Saturated | 18 |
| Toner 22 | 8.62E−06 | 3.16E−06 | 2.73 | Saturated | 18 |
| Toner 23 | 8.62E−06 | 3.16E−06 | 2.73 | Saturated | 18 |
| Toner 24 | 8.62E−06 | 3.16E−06 | 2.73 | Saturated | 18 |
| Toner 25 | 8.62E−06 | 3.16E−06 | 2.73 | Saturated | 18 |
| Toner 26 | 8.62E−06 | 3.16E−06 | 2.73 | Saturated | 18 |
| Toner 27 | 8.62E−06 | 3.16E−06 | 2.73 | Saturated | 18 |
| Toner 28 | 0.00E+00 | 3.16E−06 | 0.00 | Saturated | 18 |
| Toner 29 | 8.62E−07 | 0.00E+00 | — | Saturated | 18 |
| Toner 30 | 8.62E−07 | 3.16E−06 | 0.27 | Saturated | 18 |
| Toner 31 | 0.00E+00 | 3.16E−06 | 0.00 | Saturated | 18 |
| Toner 32 | 4.31E−06 | 4.74E−08 | 90.80 | Saturated | 18 |

TABLE 6-2

| | | | | Fatty |
|---|---|---|---|---|
| | | | | acid |
| | | | | metal |
| | Fatty acid | | Fatty acid metal | salt SP |
| | species | Metal type | salt species | value |
| Toner 1 | Stearic acid | Zinc | Zinc stearate | 18.73 |
| Toner 2 | Stearic acid | Zinc | Zinc stearate | 18.73 |
| Toner 3 | Stearic acid | Zinc | Zinc stearate | 18.73 |
| Toner 4 | Stearic acid | Zinc | Zinc stearate | 18.73 |
| Toner 5 | Stearic acid | Zinc | Zinc stearate | 18.73 |
| Toner 6 | Stearic acid | Zinc | Zinc stearate | 18.73 |
| Toner 7 | Stearic acid | Zinc | Zinc stearate | 18.73 |
| Toner 8 | Stearic acid | Zinc | Zinc stearate | 18.73 |
| Toner 9 | Stearic acid | Zinc | Zinc stearate | 18.73 |
| Toner 10 | Stearic acid | Zinc | Zinc stearate | 18.73 |
| Toner 11 | Stearic acid | Zinc | Zinc stearate | 18.73 |
| Toner 12 | Stearic acid | Zinc | Zinc stearate | 18.73 |
| Toner 13 | Stearic acid | Zinc | Zinc stearate | 18.73 |
| Toner 14 | Montanic acid | Zinc | Zinc montanate | 18.32 |
| Toner 15 | Behenic acid | Zinc | Zinc behenate | 18.53 |
| Toner 16 | Lauric acid | Zinc | Zinc laurate | 19.26 |
| Toner 17 | Stearic acid | Aluminum | Aluminum | 18.56 |
| | | | stearate | |
| Toner 18 | Octylic acid | Aluminum | Aluminum | 19.32 |
| | | | octylate | |
| Toner 19 | Stearic acid | Barium | Barium stearate | 18.77 |
| Toner 20 | Ricinoleic acid | Barium | Barium | 20.67 |
| | | | ricinoleate | |
| Toner 21 | Stearic acid | Zinc | Zinc stearate | 18.73 |
| Toner 22 | Stearic acid | Zinc | Zinc stearate | 18.73 |
| Toner 23 | Stearic acid | Zinc | Zinc stearate | 18.73 |
| Toner 24 | Stearic acid | Zinc | Zinc stearate | 18.73 |
| Toner 25 | Stearic acid | Zinc | Zinc stearate | 18.73 |
| Toner 26 | Stearic acid | Zinc | Zinc stearate | 18.73 |
| Toner 27 | Stearic acid | Zinc | Zinc stearate | 18.73 |
| Toner 28 | Stearic acid | Zinc | Zinc stearate | 18.73 |
| Toner 29 | Stearic acid | Zinc | Zinc stearate | 18.73 |
| Toner 30 | Stearic acid | Zinc | Zinc stearate | 18.73 |
| Toner 31 | Stearic acid | Zinc | Zinc stearate | 18.73 |
| Toner 32 | Stearic acid | Zinc | Zinc stearate | 18.73 |

In the Tables 6-1 and 6-2, a denotes the content (mol/g) of fumaric acid in the toner, and b denotes the content (mol/g) of a fatty acid metal salt particle in the toner; for instance 8.62E-06 represents 8.62×10⁻⁶.

TABLE 7

| | Release | Release | Release | | | | | SP |
|---|---|---|---|---|---|---|---|---|
| | agent | agent | agent | Molecular | | | Peak | value |
| | melting | molecular | SP | weight * | | PES | molecular | of |
| | point | weight | value | ΔSPpw² | ΔSPfw | content | weight | resin |
| Toner 1 | 90 | 771 | 17.16 | 11428.15 | 1.57 | Y | 6000 | 21.01 |
| Toner 2 | 82 | 1426 | 18.15 | 11664.11 | 0.58 | Y | 6000 | 21.01 |
| Toner 3 | 90 | 771 | 17.16 | 11428.15 | 1.57 | Y | 6000 | 21.01 |
| Toner 4 | 90 | 771 | 17.16 | 11428.15 | 1.57 | Y | 6000 | 21.01 |
| Toner 5 | 90 | 771 | 17.16 | 11428.15 | 1.57 | Y | 6000 | 21.01 |
| Toner 6 | 90 | 771 | 17.16 | 13087.26 | 1.57 | Y | 6000 | 21.28 |
| Toner 7 | 90 | 771 | 17.16 | 11428.15 | 1.57 | Y | 6000 | 21.01 |
| Toner 8 | 90 | 771 | 17.16 | 11428.15 | 1.57 | Y | 6000 | 21.01 |
| Toner 9 | 90 | 771 | 17.16 | 11428.15 | 1.57 | Y | 6000 | 21.01 |
| Toner 10 | 82 | 1426 | 18.15 | 11664.11 | 0.58 | Y | 6000 | 21.01 |
| Toner 11 | 82 | 1426 | 18.15 | 11664.11 | 0.58 | Y | 6000 | 21.01 |
| Toner 12 | 82 | 1426 | 18.15 | 11664.11 | 0.58 | Y | 6000 | 21.01 |
| Toner 13 | 82 | 1426 | 18.15 | 11664.11 | 0.58 | Y | 6000 | 21.01 |
| Toner 14 | 82 | 1426 | 18.15 | 11664.11 | 0.17 | Y | 6000 | 21.01 |
| Toner 15 | 82 | 1426 | 18.15 | 11664.11 | 0.38 | Y | 6000 | 21.01 |
| Toner 16 | 82 | 1426 | 18.15 | 11664.11 | 1.11 | Y | 6000 | 21.01 |
| Toner 17 | 82 | 1426 | 18.15 | 11664.11 | 0.41 | Y | 6000 | 21.01 |
| Toner 18 | 82 | 1426 | 18.15 | 11664.11 | 1.17 | Y | 6000 | 21.01 |
| Toner 19 | 82 | 1426 | 18.15 | 11664.11 | 0.62 | Y | 6000 | 21.01 |
| Toner 20 | 82 | 1426 | 18.15 | 11664.11 | 2.52 | Y | 6000 | 21.01 |
| Toner 21 | 82 | 1426 | 18.15 | 5256.81 | 0.58 | N | 20000 | — |
| Toner 22 | 73 | 1685 | 18.44 | 11129.26 | 0.29 | Y | 6000 | 21.01 |
| Toner 23 | 73 | 649 | 17.56 | 7724.72 | 1.17 | Y | 6000 | 21.01 |
| Toner 24 | 67 | 593 | 17.57 | 7017.32 | 1.16 | Y | 6000 | 21.01 |
| Toner 25 | 75 | 469 | 16.94 | 7768.94 | 1.79 | Y | 6000 | 21.01 |
| Toner 26 | 90 | 771 | 17.16 | 11428.15 | 1.57 | Y | 12000 | 21.01 |
| Toner 27 | 75 | 469 | 16.94 | 7768.94 | 1.79 | Y | 6000 | 21.01 |
| Toner 28 | 67 | 593 | 17.57 | 7017.32 | 1.16 | Y | 6000 | 21.01 |
| Toner 29 | 90 | 771 | 17.16 | 11428.15 | 1.57 | Y | 6000 | 21.01 |
| Toner 30 | 90 | 771 | 17.16 | 11428.15 | 1.57 | Y | 6000 | 21.01 |
| Toner 31 | 67 | 593 | 17.57 | 8162.11 | 1.16 | Y | 6000 | 21.28 |
| Toner 32 | 90 | 771 | 17.16 | 11428.15 | 1.57 | Y | 6000 | 21.01 |

In the table, PES content denotes the presence or absence of a polyester resin in the binder resin, Y denotes that the binder resin comprises a polyester resin, and N denotes that the binder resin does not comprise polyester resin. Further, ΔSPpw represents a difference between the solubility parameter SPp of the polyester resin and the solubility parameter SPw of the release agent, ΔSPfw represents the difference between the solubility parameter SPf of the fatty acid metal salt and SPw, and the peak molecular weight denotes the peak molecular weight of the binder resin.

### Examples 1 to 27, and Comparative Examples 1 to 5

The following evaluations were performed using the above Toners 1 to 32. Evaluation results are given in Table 8.

An explanation follows next on evaluation methods and evaluation criteria in the present disclosure.

As the image forming apparatus there were used a modified LBP-712Ci (by Canon Inc.) which is a commercially available laser printer, modified herein to have a process speed of 200 mm/sec, and also a toner cartridge 040H (black) (by Canon Inc.) which is a commercially available process cartridge. The product toner was removed from the interior of the cartridge, which was then cleaned by air blowing, after which the cartridge was filled with 165 g of the toner to be evaluated. Product toner was retrieved from each of the yellow, magenta and cyan stations, and a yellow cartridge, a magenta cartridge and a cyan cartridge in which a toner residual amount detection mechanism had been disabled were inserted, and an evaluation was carried out.

Herein 10 prints of a solid black image having a toner laid-on level of 0.50 g/cm² were outputted using BROCHURE PAPER 150 g GLOSSY paper (by HP Inc. 150 g/m²), in a normal-temperature, normal-humidity environment (25° C./50% RH; hereafter N/N environment).

Abrasion Resistance of an Image and Gloss of the Image after Rubbing

Among the solid black images that were obtained, the 10th sample was rubbed 10 times under a load of 7.35 kPa at five points on the image, namely top left, top right, center, bottom left and bottom right, and it was checked that there were no changes in image density between before and after rubbing. Thereafter, the same sample was rubbed a further 100 times using a rubbing tester, and the abrasion resistance of the image was ascertained on the basis of changes in density before and after rubbing.

To measure image density, a relative density with respect to a printout image having a white background portion of 0.00 original density was measured using a color reflection densitometer X-RITE 404A (by X-Rite Co.), and there was calculated a rate of decrease of image density after rubbing relative to image density before rubbing. The evaluation criteria are given below.

Also the gloss of the image after rubbing was measured using a Handy Gloss Meter PG-3D (by Nippon Denshoku Industries Co., Ltd.) at a light incidence angle of 75°. The evaluation criteria are given below.

In the test, the density did not change between before and after 10 rubs; this was accordingly indicative of sufficient fixing of the image onto the paper. In a case where density decreased after 100 rubs, it was therefore determined that image loss had occurred on account of a drop in in the slipperiness of the image surface.

### Image Abrasion Resistance

### Evaluation Criteria

A: Density decrease rate lower than 1%
B: Density decrease rate from 1% to less than 3%
C: Density decrease rate from 3% to less than 10%
D: Density decrease rate of 10% or higher

### Gloss of the Image After Rubbing

### Evaluation Criteria

A: Image gloss of 70 or higher
B: Image gloss from 60 to less than 70
C: Image gloss from 50 to less than 60
D: Image gloss lower than 50

### Image Heat Resistance

From among the solid black images obtained, the 8th sample and the 9th sample were stacked on each other so that the image surfaces came in contact with each other, and a load of 7.35 kPa was laid on the stack, which was allowed to stand at 50° C. for 24 hours. The heat resistance of the image was evaluated on the basis of the sticking after standing. The evaluation criteria were as follows.

### Evaluation Criteria

A: No observable sticking
B: Slight sticking observable, but leaving no trace even after peeling.
C: Sticking visible, with slight image loss upon peeling.
D: Conspicuous sticking, with noticeable image loss upon peeling.

### Image Taping Resistance

Mylar tape (by Nitto Denko) was affixed, under a load of 7.35 kPa, to the center of the 7th sample image from among the obtained solid black images. The affixed tape was thereafter stripped off slowly, and the taping resistance of the image was evaluated on the basis of the criteria below, depending on the state of image loss. The evaluation criteria were as follows. High taping resistance in an image is indicative of high strength of the image surface.

### Evaluation Criteria

A: No observable sticking to the tape.
B: Slight sticking to the tape, but without image loss.
C: Slight image loss
D: Conspicuous image loss

### Image Density and Image Density Non-Uniformity

The above image forming apparatus was allowed to stand for 24 hours in a high-temperature, high-humidity environment (30° C./80% RH, hereafter also referred to as H/H environment). In this H/H environment, an initial image sample was obtained in the form of an outputted solid black image having a toner laid-on level of 0.50 g/cm², on Canon color laser copier paper (A4:81.4 g/m²). A horizontal line image having a print percentage of 1% was thereafter continuously outputted over 5000 prints. One print of a solid black image having a toner laid-on level of 0.50 g/cm² was outputted, on Canon color laser copier paper (A4:81.4 g/m²) immediately after continuous output of the 5000 prints, and also after 60 hours of standing following continuous output of 5000 prints. The density of the obtained images was measured, and the rate of change in density relative to the initial image sample was checked. The image density exhibiting the highest rate of change, from among the sample immediately following continuous output of 5000 prints and the sample having been allowed to stand for 60 hours after continuous output of 5000 prints, was taken herein as the image density change rate of the sample, which was evaluated in accordance with the criteria below.

The image density of the initial image sample was measured at five points in a same image, and the image density change of the point of lowest image density referred to the point of highest image density was taken herein as the image density non-uniformity, which was evaluated in accordance with the criteria below. Specifically, the five points were measured, namely point A standing 3 cm off the image left edge and 3 cm off the image upper end, point B standing 3 cm off the image left edge and 3 cm off the image lower end, point C standing 3 cm off the image right edge and 3 cm off the image upper end, point D standing 3 cm off the image right edge and 3 cm off the image lower end, and point E on the image center.

### Image Density

### Evaluation Criteria

A: Change in image density lower than 3%
B: Change in image density from 3% to less than 5%
C: Change in image density from 5% to less than 10%
D: Change in image density of 10% or higher

### Image Density Non-Uniformity

### Evaluation Criteria

A: Change in image density lower than 3%
B: Change in image density from 3% to less than 5%
C: Change in image density from 5% to less than 10%
D: Change in image density of 10% or higher

### Charging Roller Contamination

The above image forming apparatus was allowed to stand for 24 hours in a low-temperature, low-humidity environment (15° C./10% RH, hereafter also referred to as L/L environment). Thereafter, 5000 prints of a horizontal line image having a print percentage of 1% were continuously outputted on Canon color laser copier paper (A4: 81.4 g/m²) in an L/L environment. Subsequently, one halftone image having a toner laid-on level of 0.20 g/cm² was outputted on Canon color laser copier paper (A4: 81.4 g/m²). Thereafter, the cartridge was taken apart and the surface of the charging roller (charging member) was observed.

### Evaluation Criteria

A: No observable streaks on the charging member
B: Slight streaks observable on the charging member, but no streaks observable
on the image
C: Streaks observable on the charging member, with slight streaks observable
also on the image
D: Conspicuous streaks on the image

TABLE 8

| | Image | Image | Image | Image | | Image | Charging |
|---|---|---|---|---|---|---|---|
| | abrasion | gloss after | heat | taping | Image | density non- | roller |
| | resistance | rubbing | resistance | resistance | density | uniformity | contamination |
| Example 1 | A | B | A | A | A | A | A |
| Example 2 | A | A | A | A | A | A | A |
| Example 3 | A | B | A | A | A | A | A |
| Example 4 | B | B | A | A | A | A | A |
| Example 5 | C | B | A | A | B | A | A |
| Example 6 | C | B | A | A | B | A | A |
| Example 7 | A | B | A | A | C | A | A |
| Example 8 | A | B | A | A | B | A | A |
| Example 9 | C | B | A | A | C | A | A |
| Example 10 | A | A | A | A | A | A | B |
| Example 11 | B | A | A | A | A | A | A |
| Example 12 | B | A | A | A | A | A | B |
| Example 13 | C | B | A | A | A | A | C |
| Example 14 | B | A | A | A | A | A | B |
| Example 15 | A | A | A | A | A | A | A |
| Example 16 | A | B | A | A | A | A | A |
| Example 17 | B | A | A | A | A | A | A |
| Example 18 | B | B | C | A | A | A | B |
| Example 19 | B | A | A | A | A | A | A |
| Example 20 | B | C | A | A | A | A | A |
| Example 21 | C | A | A | C | B | A | A |
| Example 22 | A | A | B | A | B | A | A |
| Example 23 | A | B | B | B | B | A | A |
| Example 24 | A | B | C | B | B | A | A |
| Example 25 | A | C | B | B | B | A | A |
| Example 26 | C | B | A | B | A | A | A |
| Example 27 | A | C | B | B | A | C | C |
| Comparative | D | D | C | C | C | A | A |
| Example 1 | | | | | | | |
| Comparative | D | D | C | B | B | A | D |
| Example 2 | | | | | | | |
| Comparative | D | D | C | B | B | A | A |
| Example 3 | | | | | | | |
| Comparative | D | D | C | C | B | A | A |
| Example 4 | | | | | | | |
| Comparative | D | D | C | B | A | A | C |
| Example 5 | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-076059, filed May 2, 2023 which is hereby incorporated by reference herein in its entirety.

What is claimed is:

1. A toner comprising
a toner particle comprising a binder resin, and
an external additive,
wherein the external additive comprises a fatty acid metal salt particle;
the toner comprises fumaric acid;
with a (mol/g) as a content of the fumaric acid in the toner, and
with b (mol/g) as a content of the fatty acid metal salt particle in the toner, Formula (1) below is satisfied:
$$0.50 \leq a / b \leq 70 \text{.00} . \qquad ( 1 )$$

2. The toner according to claim 1, wherein Formula (2) below is satisfied:
$$1.2 \leq a / b \leq 70 \text{.00} . \qquad ( 2 )$$

3. The toner according to claim 2, wherein Formula (3) below is satisfied:
$$1.5 \leq a / b \leq 70 \text{.00} . \qquad ( 3 )$$

4. The toner according to claim 1, wherein the content a (mol/g) of the fumaric acid in the toner is 8.60×10⁻⁷ to 1.05×10⁻⁵ mol/g.

5. The toner according to claim 1, wherein the content b (mol/g) of the fatty acid metal salt particle in the toner is 1.55×10⁻⁷ to 7.90×10⁻⁶ mol/g.

6. The toner according to claim 1, wherein the fatty acid metal salt is a metal salt of a saturated fatty acid having 12 to 22 carbon atoms.

7. The toner according to claim 6, wherein the fatty acid metal salt is a metal salt of stearic acid.

8. The toner according to claim 1, wherein the fatty acid metal salt is a zinc salt.

9. The toner according to claim 8, wherein the fatty acid metal salt is zinc stearate.

10. The toner according to claim 1, wherein the toner particle comprises a release agent.

11. The toner according to claim 10, wherein a melting point of the release agent is 70 to 120° C.

12. The toner according to claim 11, wherein the melting point of the release agent is 80 to 120° C.

13. The toner according to claim 1, wherein the binder resin comprises a polyester resin.

14. The toner according to claim 13,
wherein the toner particle comprises a release agent; and
with SPp ((J/cm³)^{1/2}) as a solubility parameter of the polyester resin, SPw ((J/cm³)^{1/2}) as a solubility parameter of the release agent, and ΔSPpw as a difference between SPp and SPw,
a product of the square of ΔSPpw and a molecular weight of the release agent is 10000.00 (J/cm³) or more.

15. The toner according to claim 10,
wherein with SPf ((J/cm³)^{1/2}) as a solubility parameter of the fatty acid metal salt, SPw ((J/cm³)^{1/2}) as a solubility parameter of the release agent, and ΔSPfw as a difference between SPf and SPw,
ΔSPfw is 0.20 to 1.60.

16. The toner according to claim 1, wherein a peak molecular weight Mp of the binder resin is 5000 to 10000.
